(19) United States
(12) Patent Application Publication
(10) Pub. No.: US 2025/0380107 A1
(43) Pub. Date: Dec. 11, 2025

(54) SYSTEM FOR DETERMINING CUSTOMIZED AUDIO

(71) Applicant: Google LLC, Mountain View, CA (US)

(72) Inventor: Rajeev Nongpiur, Mountain View, CA (US)

(21) Appl. No.: 18/901,374

(22) Filed: Sep. 30, 2024

Related U.S. Application Data
(63) Continuation-in-part of application No. 18/841,545, filed on Aug. 26, 2024.

(51) Int. Cl. H04S 7/00

(52) U.S. Cl. CPC H04S 7/307; H04S 7/303; H04S 2420/01

(57) ABSTRACT

Disclosed implementations for generating personalized audio. In response to receiving sensor data corresponding with a physical characteristic of a user, a model is scaled to the physical characteristic. A function representing an audio response is modified based on the scaled model to produce a modified function. An audio stream is generated based on the modified function.

### CROSS-REFERENCE TO RELATED APPLICATIONS

This application is a continuation-in-part of, and claims priority to, U.S. patent application Ser. No. 18/841,545, filed on Aug. 26, 2024, entitled “SYSTEM FOR DETERMINING CUSTOMIZED AUDIO”, which is a 35 U.S.C. § 371 National Phase Entry Application from PCT/US2024/033007, filed on Jun. 7, 2024, entitled “SYSTEM FOR DETERMINING CUSTOMIZED AUDIO”, the disclosures of which are incorporated by reference herein in their entirety.

### BACKGROUND

Sound reproduction is the process of recording, processing, storing, and recreating sound, such as speech, music, and the like. When recording a sound, one or more audio sensors are used to capture sound in single or multiple positions for a recording device.

### SUMMARY

An audio signal can be customized for a listener using a personalized audio profile (or function). The personalized audio profile can be a type of audio listening profile configured specifically for the listener. Current approaches for generating a personalized audio profile for a listener include making measurements for the listener in an anechoic chamber using audio equipment. At least one technical problem with this approach is that such an approach is expensive and not feasible with typical user computing devices.

The implementations described herein provide at least one technical solution to these technical problems by generating a personalized audio profile for a listener from data collected by the listener using a personal computing device (e.g., a mobile device). In some example implementations, a listener can, via a computing device, broadcast sound and record both the sound and the position of the listener. In such example implementations, the listener is provided with instructions to record, in particular, his or her head while the sound is broadcast and recorded. The personalized audio profile is determined based on the recorded visual data and audio data. In other examples implementation, a user can, via a computing device, record visual and position data of his or her head and ears (in particular the pinna (or pinnae plural), which are the external part of the ear). In such example implementations, the user is provided with instructions for how to move the device when recording. The personalized audio profile is determined based on the recorded visual data.

The personalized audio profiles determined in the example implementation above can be employed to render audio tailored specifically to the unique physical characteristics of the listener and thereby making the experience more immersive. The personalized audio profile may be referred to as a personalized response or as a personalized impulse response.

It is appreciated that methods and systems, in accordance with the present disclosure, can include any combination of the aspects and features described herein. That is, methods in accordance with the present disclosure are not limited to the combinations of aspects and features specifically described herein, but also may include any combination of the aspects and features provided.

Accordingly, in one example, a method includes receiving an audio signal and sensor data captured while a sound is broadcast from an audio source; determining position data for the audio source based on the sensor data; determining a first response based on the audio signal and the position data, the first response characterizing a response of the audio signal as a function of time; determining a second response by applying a filter to the first response; and generating an audio stream based on the second response.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 is an example environment where a device is employed to determine a personalized impulse response for a user, according to an implementation of the described system;

FIG. 2A is an example architecture that can be employed to execute implementations of the present disclosure;

FIG. 2B is an example architecture of a response module, according to an implementation of the described system;

FIG. 3A is a block diagram of an example architecture that can be employed to execute implementations of the present disclosure;

FIG. 3B is a block diagram of an example architecture of a combiner module, according to an implementation of the described system;

FIG. 4 is an example environment that can be employed to execute implementations of the present disclosure;

FIG. 5A is a flowchart of another non-limiting process that can be performed by implementations of the present disclosure;

FIG. 5B is a flowchart of another non-limiting process that can be performed by implementations of the present disclosure; and

FIG. 6 is an example system that includes a computer or computing device that can be programmed or otherwise configured to implement systems or methods of the present disclosure.

### DETAILED DESCRIPTION

Humans locate sounds in three dimensions, even though we have only two ears, because the brain, inner ear, and the external ears (pinna) work together to make inferences about location. Generally, humans can estimate the location of a source of a sound based on cues derived from one ear (monaural cues) that are compared to cues received at both ears (difference cues or binaural cues). Among these difference cues are time differences of arrival of sounds and intensity differences of sounds. For example, sound travels outward from a sound source in all directions via sound waves that reverberate (or reflect) off of objects near the sound source. These sound waves bounce off an object and/or portions of the listener's body and can be altered in response to the impact. When the sound waves reach a listener (either directly from the source and/or after reverberating off an object[s]) they are converted by a listener's body and interpreted by the listener's brain. Accordingly, sounds are interpreted and processed by a listener in a personalized way based on the unique physical characteristics of the listener.

Sounds reproduced using audio equipment can be personalized or customized for a listener in a personalized audio profile, which can be used to improve the listening experience of the listener based on one or more of their physical characteristics. At least one technical problem with current approaches for generating such a personalized audio profile for a listener is that the current approaches often involve the use of complicated techniques and expensive equipment for making measurements for the listener.

At least one of the technical solutions to the technical problem described above includes generating personalized audio for a listener from data collected by the listener (and for the listener) using a typical personal computing device (e.g., a mobile device). The personalized audio can be used to render audio tailored specifically to the unique physical characteristics of the listener and thereby make the listening experience more immersive. The personalized audio profile can be generated (e.g., defined) using a variety of techniques including the use of impulse responses, transfer functions, and/or convolutions. Some aspects of impulse responses, transfer functions, and convolutions are described in more detail below by way of introduction.

A listener derives the monaural cues from the interaction between a sound source and the listener's anatomy where the original source sound is modified before entering the ear canal for processing by the auditory system. These modifications encode the source location and may be captured via an impulse response (also can be referred to as a response or as an audio response) that relates the source location and the ear location. More generally, the impulse response is the reaction of any dynamic system (e.g., the listener) in response to some external change (e.g., the audio signal). The impulse response can be configured to characterize the reaction of the dynamic system as a function of time (or possibly as a function of some other independent variable that parametrizes the dynamic behavior of the system). In some implementations, this impulse response is termed the head-related impulse response (HRIR) in the contest of a listener's response to an audio signal.

A transfer function is an integral transform, specifically a Fourier transform, of an impulse response. An integral transform can be an operation that converts or maps a function from its original function space (a set of functions between two fixed sets) into another function space. This transfer function can be referred to as the head-related transfer function (HRTF) and describes the spectral characteristics of sound measured at the tympanic membrane (the eardrum) when the source of the sound is in three-dimensional space. A transfer function, and specifically an HRTF, can be used to simulate externally presented sounds when the sounds are introduced through, for example, headphones. More generally, an HRTF is a function of frequency, azimuth, and elevation determined primarily by the acoustical properties of the external ear, the head, and the torso of an individual. As such, HRTFs can differ substantially across individuals. In this case, the function space of the impulse response is the time domain (how a frequency changes over time) while the function space of the transfer function is the frequency domain (how a signal is distributed within different frequency bands over a range of frequencies). However, both the impulse response (e.g., HRIR) and the transfer function (HRTF), in some implementations, can characterize the transmission between a sound source and the eardrums of a listener.

Said differently, how an ear receives a sound (e.g., sound waves) from a point in space (e.g., a sound source) can be characterized using a transfer function or an impulse response. Both the impulse response and transfer function describe the acoustic filtering or modifications to a sound, due to the presence of a listener (and/or any object), from a direction to the sound as the sound propagates in free field and arrives at the ear (more specifically the eardrum). In some implementations, both the impulse response and transfer function describe the acoustic filtering or modifications to a sound, due to the presence of an object, from a direction to the sound as the sound propagates in free field and arrives at a portion of the object. As sound reaches the listener, the shape of the listener's body (especially the shape of the listener's head and pinnae) modifies the sound and affects how the listener perceives the sound. Specifically, an HRTF is defined as the ratio between the Fourier transform of the sound pressure at the entrance of the ear canal and the Fourier transform of the sound pressure in the middle of the head in the absence of the listener. HRTFs are therefore filters quantifying the effect of the shape of the head, body, and pinnae on the sound arriving at the entrance of the ear canal.

These modifications include, most notably, the shape of the listener's ear (especially the shape of the listener's outer ear); the shape, size, and mass, of the listener's head and body; the length and diameter of the ear canal; the dimensions of the oral and sinus cavities; as well as the acoustic characteristics of the space in which the sound is played can all manipulate the incoming sound waves by boosting some frequencies and attenuating others. All of these characteristics influence how (or whether) a listener can determine the direction of the sound's source (e.g., from where the sound is coming). These modifications create a unique perspective and perception for each listener as well as help the listener pinpoint the location of the sound source.

A convolution can include the process of multiplying the frequency spectra of two audio sources such as, for example, an input audio signal and an impulse response. The frequencies that are shared between the two sources are accentuated, while frequencies that are not shared are attenuated. Convolution causes an input audio signal to take on the sonic qualities of the impulse response, as characteristic frequencies from the impulse response common in the input signal are boosted. Put another way, convolution of an input sound source with the impulse response converts the sound to that which would have been heard by the listener if the sound had been played at the source location, with the listener's ear at the receiver location. In this way, impulse responses (e.g., an HRIR or an HRTFs) are used to produce virtual surround sound.

A convolution is more efficient (e.g., becomes a multiplication) in the frequency (Fourier) domain and therefore transfer functions are preferred when generating an audio signal for an individual via convolution. Accordingly, a pair of transfer functions (e.g., one HRTF for each ear) can be used to synthesize a binaural sound that is perceived as originating from a particular point in space. Moreover, some consumer home entertainment products designed to reproduce surround sound from stereo audio devices (e.g., two or more speakers) can use some form of a transfer function(s). Some forms of transfer function processing have also been included in computer software to simulate surround sound playback from loudspeakers.

As noted above, current approaches for generating a personalized transfer function (or personalized impulse responses) for a listener (and/or any object) include measurements collected in an anechoic chamber using audio equipment. At least one technical problem with this approach is that such an approach is expensive and not feasible with user computing devices. Said differently, such an approach does not scale to consumer devices. Another approach includes employing a neural network model or signal processing algorithm to determine an appropriate personalized transfer function based on images of the user's head and/or pinna. However, at least one technical problem with this approach is that the personalized transfer function determined by such an approach may not be very accurate (e.g., well fitting for the user) as the intricate sound diffraction across the ridges and undulation within the pinna are not captured. Moreover, measurements collected in an anechoic chamber take a considerable amount of time and the process is not user-friendly.

The implementations described herein provide at least one technical solution to these technical problems. In particular, implementations of the described system generate an impulse response (e.g., a personalized impulse response) for a user (and/or object) using a computing device (e.g., a mobile device) and in-ear microphones. A transfer function can then be generated based on the impulse response (e.g., using an inverse transfer function). Other implementations of the described system provides a measurement-based approach for generating a transfer function (e.g., a personalized transfer function) for a user (and/or object) using a computing device (e.g., a mobile device) and in-ear microphones. The transfer function can then be used to generate an audio signal. For example, an audio signal that is specifically tailored to a user (e.g., via headphones or loudspeakers).

In an example scenario, the computing device broadcasts sound (e.g., white noise broadcast via a loudspeaker) and provides instructions (e.g., via the display) for the user to move the device around his or her head. In such an example, the computing device may be configured to record, as the user moves the device, the broadcasted sound via the in-ear microphones and sensor data (e.g., video, inertial measurement unit (IMU) data) via sensors such as an imaging device (e.g., a camera) and/or (IMU) sensor. The sensor data may include, for example, position information of the user (e.g., in particular, the position of the user's head) as well as head and body movement of the user while the sound is broadcast. In some implementations, the computing device is configured to determine, based on the sensor data, the spatial coordinates of the device with respect to the user's head. The computing device may then determine the personalized impulse response for the user based on these spatial coordinates and the recorded audio.

In another example scenario, the computing device provides instructions (e.g., via a display) for the user to move the device around his or her head. In such an example, the computing device may be configured to record, as the user moves the device, sensor data (e.g., video, IMU data) via sensors such as an imaging device and/or an IMU sensor. The sensor data may include, for example, position information of the user (e.g., in particular, the position of the user's head and pinnae) as well as head and body movement of the user during recording. In some implementations, the computing device is configured to determine, based on the sensor data, the spatial coordinates of the device with respect to the user's head. The computing device may then determine the personalized transfer function for the user based on these spatial coordinates and the recorded sensor data.

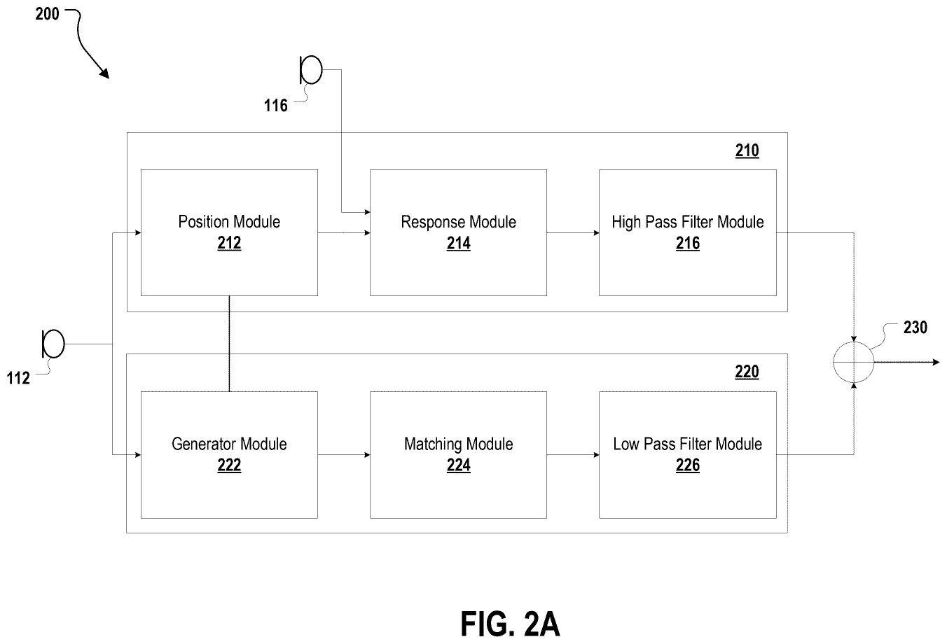

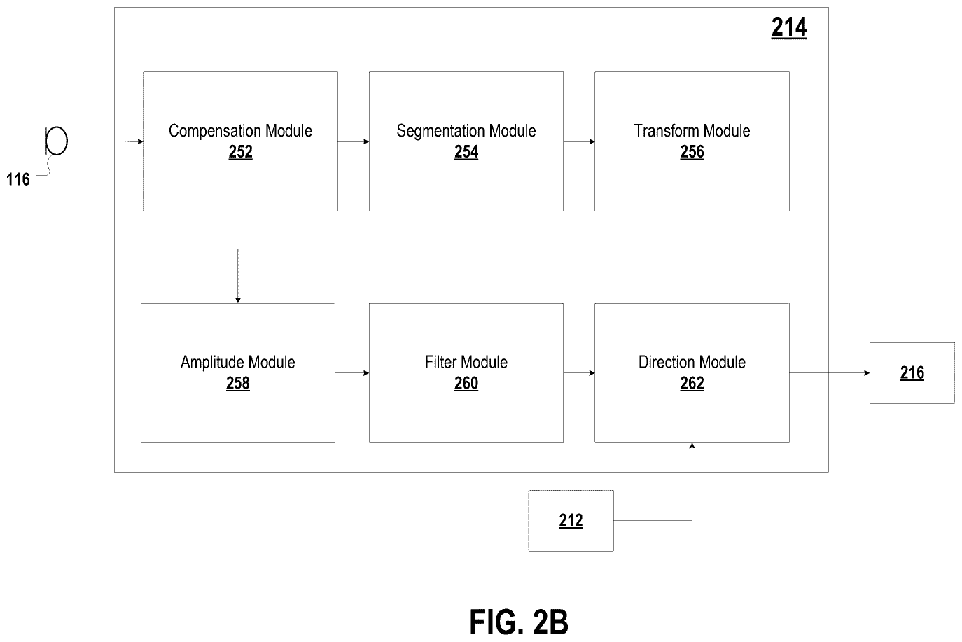

In some implementations, the described system determines a personalized impulse response based on an audio signal as well as sensor data captured while the sound is broadcast from an audio source (e.g., a speaker embedded in a mobile device). More specifically, a user may employ a device (e.g., a mobile device) to broadcast sound (e.g., white noise). While the sound is broadcast, the user may receive instructions for how to move the device around his or her head. The position of the user (e.g., the user's head and body position[s]) is captured via an imaging sensor (e.g., a camera and/or an IMU sensor) while simultaneously (or substantially simultaneously), a recording device (e.g., two microphone embedded in the user's ears) captures the audio signal. Position data (related to the position of the user during the broadcast) is determined based on the recorded sensor data (e.g., video, IMU data). In some cases, for example, this position data includes positional information of the user's head in relation to the audio source and recording device, which is synchronized with the audio signal. Multiple impulse responses are determined (see the descriptions of FIGS. 2A and 2B below for more detail) based on the recording and the position data. In some cases, a filter (e.g., a high-pass filter) is applied to the impulse responses personalized impulse response for the user.

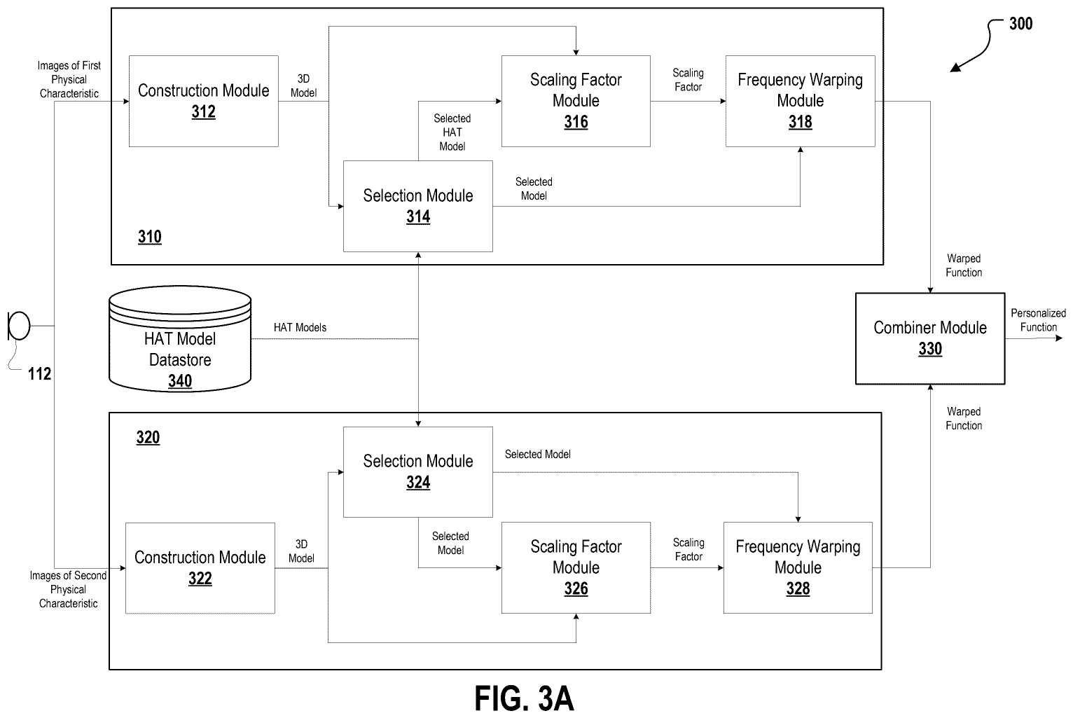

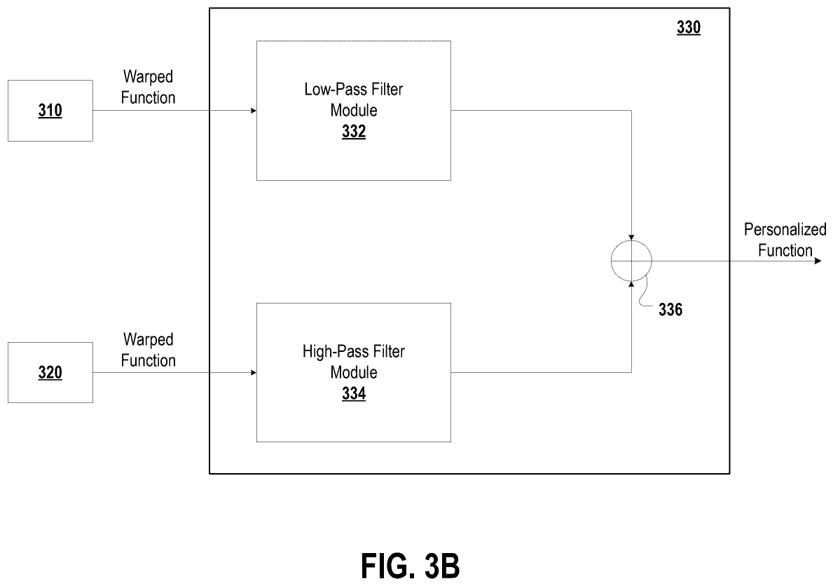

In some implementations, the described audio signal personalization system determines a personalized transfer function based on sensor data captured as the user moves the device around his or her head. More specifically, a user employs a device (e.g., a mobile device) to capture sensor data (e.g., image data). The user may receive instructions for how to move the device around his or her head. The position of the user (e.g., the user's head and body position[s]) is captured via an imaging sensor (e.g., a camera and/or an IMU sensor). Position data (related to the position of the user) is determined based on the recorded sensor data (e.g., video, IMU data). In some cases, for example, this position data includes positional information of the user's head in relation to the device. A three-dimensional (3D) representation of the user's head and a 3D representation of the user's pinnae are generated with the video and IMU sensor signals. A head-and-torso (HAT) model and associated HRTF are selected based on each 3D representation. The HAT models are scaled to fit the respective 3D representation and the associated HRTFs are modified (warped) based on the respective scaling factors. In some cases, a filter (e.g., a high-pass filter and a low-pass filter) is applied to the modified HRTFs, which are combined to form the personalized transfer function for the user (see the descriptions of FIGS. 3A and 3B below for more detail).

At least one technical effect can be the ability to personalize the transfer function (or audio profile for a listener) which can provide the user with a more immersive and accurate spatial-audio experience. Having a more immersive and accurate spatial-audio experience can enable the in-ear audio devices to be used with smartphones, extended reality (XR) devices (e.g., augmented reality (AR) devices, virtual reality (VR) devices, or mixed reality (MR) devices), and other head mounted display devices. Personalizing the transfer function can, for example, be accomplished using the in-ear audio device and a mobile device. In other words, expensive systems (e.g., an anechoic chamber) may be obviated.

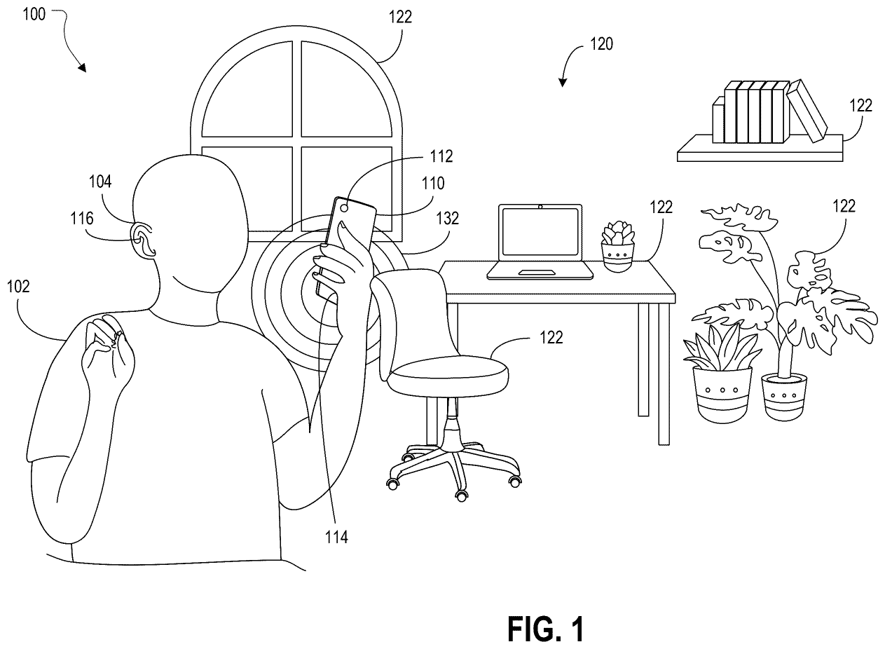

FIG. 1 illustrates a block diagram of an example environment 100 (e.g., a room) where a device 110 (e.g., a mobile device) is employed (e.g., by a user 102) to determine a personalized impulse response for the user 102 according to implementation of the described system. The device 110 can be configured to generate personalized audio for a listener from data collected by the listener (and for the listener) using the device 110. The personalized audio can be used to render audio tailored specifically to the unique physical characteristics of the user 102 and thereby make a listening experience more immersive for the user 102. The personalized audio profile can be generated (e.g., defined) using a variety of techniques including the use of impulse responses, transfer functions, and convolutions, which are described in more detail below.

The device 110 includes one or more sensors 112 and one or more electroacoustic transducers 114 and is coupled to one more audio sensors 116 that may be placed in one or both of the user's ears 104. The sensors 112 are devices (e.g., a camera, IMU sensors, and the like) configured to detect and convey information in the form of images, IMU data, and the like. In some cases, IMU data includes motion data in a time-series format. This motion data may include acceleration measurements as well as angular velocity measurements, which can be represented in a three-axis coordinate system and together yield a six-dimension measurement time series stream.

The electroacoustic transducers 114 (e.g., a loudspeaker) are devices configured to convert an electrical signal into sound waves. The audio sensors 116 are devices that are configured to detect sounds and convert the detected sounds into an audio signal (e.g., an electrical audio signal). Example audio sensors include, but are not limited to, microphones, piezoelectric sensors, and capacitive sensors. FIG. 1 depicts the audio sensors 116 as coupled to the device 110 via a wired connection (e.g., wired earbuds); however, implementations of the present disclosure can be realized with audio sensors 116 coupled to the device 110 any number of ways including a wireless connection.

As depicted, the environment 100 includes features 122 and structural elements 120 (e.g., walls, floors, ceilings). FIG. 1 depicts the example environment 100 with one or more features 122 (e.g., a table books, a window, a chair, flowers, and/or the like); however, implementations of the present disclosure can be realized within an environment having any number of features as well as any configuration of the respective structural elements 120.

As depicted in FIG. 1, the user 102 moves (e.g., moves in response to an instruction in a user interface) the device 110 around his or her head. In some cases, the user moves the device as the electroacoustic transducers 114 broadcast the sound waves 132. The audio sensors 116 are configured to record the audio (e.g., generate an audio signal based on the received sound waves 132) and provide the recorded audio signal to the device 110. The audio sensors 116 may be configured to capture the sound waves 132 directly from the electroacoustic transducers 114 or indirectly after the sound waves 132 reflect off of one of the features 122 or structural elements 120. In some implementations, the audio sensors 116 are configured to capture/record samples from the sound waves 132 generated from the electroacoustic transducers 114. In some implementations, the audio sensors 116 are configured to generate a series of impulsive signals (e.g., the audio signal) based on the samples.

In some cases, for a complete recording, the user 102 moves the device 110 around his or her head to capture the audio data, video data, and/or IMU data from many possible angles and/or along one or more paths. In some cases, the user 102 receives prompts from a user interface of the device 110 that includes instructions for how and/or when to move the device 110. In some cases, the user 102 receives prompts as the audio broadcasts from the electroacoustic transducers 114. In some cases, the user interface is configured to display a map of regions of the user's head 106 and pinnae 104 that have been mapped and direct the user to the areas that have not been mapped.

In some implementations, the device 110 is configured to synchronize the audio and sensor data (e.g., video and/or IMU data). In some implementations, the device 110 is configured to process the audio data with both low-frequency processing and high-frequency processing. In some implementations, the generated low-frequency and high-frequency components are combined into a personalized impulse response for the user 102.

In some implementations, the device 110 is configured to process the sensor data (e.g., video and/or IMU data) to determine a first transfer function from a first model fit that is fit to the shape and size of the user's head 106 and second transfer function from a second model that is fit the shape and size of the user's pinnae. In some implementations, the first transfer function is processed with high-frequency processing and the second transfer function with low-frequency processing. In some implementations, the generated low-frequency and high-frequency components are combined into a personalized transfer function for the user 102.

In some implementations, for high-frequency component processing, position data is determined from the imaging data and/or the IMU data received from the sensors 112. The position data includes, for example, the direction and relative distance of the audio source (e.g., the electroacoustic transducers 114) with respect to the center of the user's 102 head (e.g., the mid-point between the ear openings). In some implementations, the device 110 is configured to determine the impulse responses across the various directions based on the position data and the recorded audio signal. In some implementations, computed impulse responses are passed through a high-pass filter to derive the high-frequency component of the personalized impulse response for the user 102.

In some implementations, for high-frequency component processing, a 3D representation of the user's head 106 is generated with the video and IMU sensor signals. The 3D head representation may be compared with corresponding head shapes in a dataset of HAT models for previously measured heads and the HAT models with best-matching model to the 3D head model is selected from the dataset. The transfer function associated with the selected HAT model scaled and frequency warped. Once scaled and warped to fit the 3D model of the user's head 106, the transfer function is passed through a high-pass filter to derive the high-frequency component of the personalized transfer function for the user 102.

In some implementations, for low-frequency component processing, a 3D representation of the user's head is reconstructed with the video and IMU sensor signals. The 3D head representation may be compared with corresponding head shapes in a dataset of previously constructed impulse responses and the impulse response with the best-matching head-shape is selected from the dataset. The selected impulse response is passed through a low-pass filter to derive the low-frequency component of the personalized impulse response for the user 102.

In some implementations, for low-frequency component processing, a 3D representation of the user's pinnae 104 is generated with the video and IMU sensor signals. The 3D pinnae representation may be compared with corresponding pinnae shapes in a dataset of HAT models for previously measured pinnae and the HAT models with best-matching model to the 3D pinnae model is selected from the dataset. The transfer function associated with the selected HAT model scaled and frequency warped. Once scaled and warped to fit the 3D model of the user's pinnae 104, the transfer function is passed through a low-pass filter to derive the low-frequency component of the personalized transfer function for the user 102.

In some implementations, the high-frequency component and the low-frequency are combined to form a personalized impulse response for the user 102. A personalized transfer function can then be obtained from the personalized impulse response by applying a transform. For discrete-time systems, the Z-transform (which converts a discrete-time signal into a complex valued frequency-domain representation) may be used. For continuous-time systems, the Laplace transform (an integral transform that converts a function of a real variable to a function of a complex variable) may be used. The Z-transform can be considered a discrete-time equivalent of the Laplace transform.

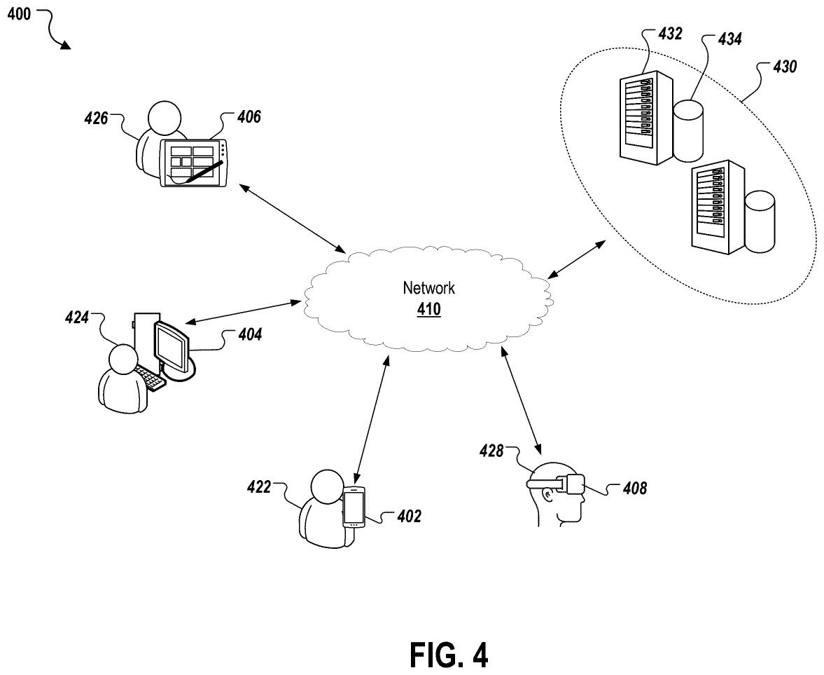

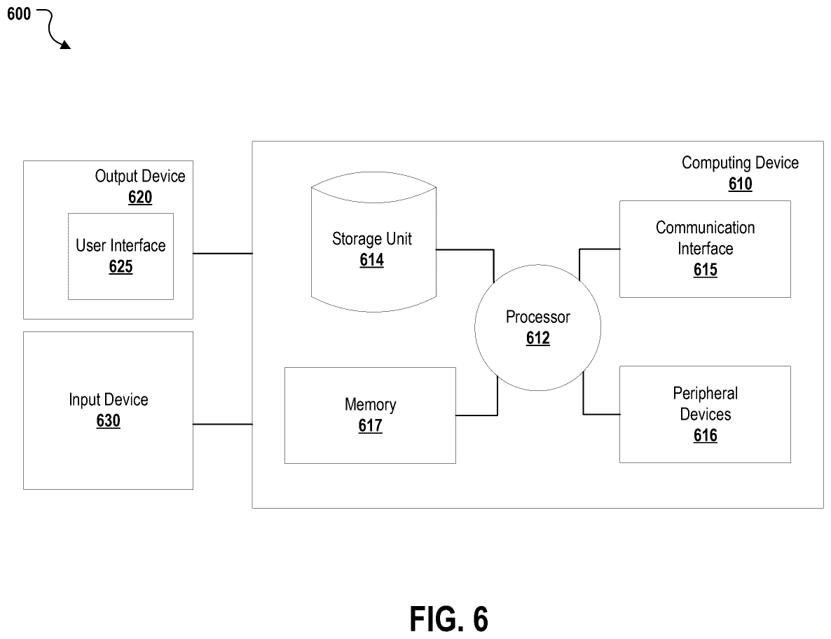

The device 110 is substantially similar to computing device 610 depicted below with reference to FIG. 6. Moreover, in the figures and descriptions included herein, device 110 is a mobile device such as a smartphone; however, it is contemplated that implementations of the present disclosure can be realized with any of the appropriate computing device(s), such as the computing devices 402, 404, 406, and 408 described below with reference to FIG. 4.

FIG. 2A is a block diagram of an example architecture 200 for the described audio signal personalization system. The example architecture 200 can be employed for the computation of a personalized impulse response. As depicted, the example architecture 200 includes a high-frequency processing module 210 and a low-frequency processing module 220. The high-frequency processing module 210 determines a high-frequency component of a personalized impulse response based on the image data and/or IMU data recorded by the sensors 112 as well as the audio data recorded by the audio sensors 116, and the low-frequency processing module 220 determines a low-frequency component of a personalized impulse response based on the image data and/or IMU data recorded by the sensors 112.

The combiner module 230 can be configured to combine the high-frequency component and low-frequency component into the resulting personalized impulse response for the user 102. In some cases, the resulting personalized impulse response is based on distances that are close to the head of the user 102 and have somewhat near-field characteristics. Accordingly, in such cases, various interpolation techniques (e.g., a function related to the scattering of sound off the user 102 or spherical harmonic decomposition) can be applied to derive a far-field version of the personalized impulse response.

As depicted in FIG. 2A, the high-frequency processing module 210 includes position module 212, response module 214, and high-pass filter module 216 and the low-frequency processing module 220 includes generator module 222, matching module 224, and low-pass filter module 226. In some implementations, the modules 210, 212, 214, 216, 220, 222, 224, and 230 are executed via an electronic processor of the device 110, depicted in FIG. 1. In some implementations, the modules 210, 212, 214, 216, 220, 222, 224, and 230 are provided via a back-end system (such as the back-end system 430 described below with reference to FIG. 4) and the device 110 is configured to communicate with the back-end system via a network (such as the communications network 410 described below with reference to FIG. 4).

In some implementations, the position module 212 (also can be referred to as a position computation module) maps a direction and relative distance of the electroacoustic transducers 114 (e.g., the source of the audio) with respect to a position of the head of the user 102 as position data over the recorded period of time (e.g., the time during with the user 102 moves the device 110 around his or her head as audio is broadcast via the electroacoustic transducers 114) based on image data and/or IMU data recorded by the sensors 112.

In some implementations, motion tracking can be employed to compute the relative orientation and position of the head of the user 102 based on received image data and/or IMU data. In some implementations, key-points for both left and right ears of the user 102 are extracted and estimated in the global frame of motion tracking. These key-points can be used to formulate ear coordinates, center of head, and calculate the relative pose of the sensors 112 with respect to the head of the user 102. In some examples, the position of the head of the user 102 is a center of the head of the user 102 determined based on a mid-point between the ear openings of the user 102. The generator module 222 described below may employ a similar technique to construct a 3D representation of the head of the user 102. The determined position data is provided to the response module 214 (which can also be referred to as an impulse response generator module) in a time-series format.

The response module 214 determines the impulse response across the various directions based on the position data and audio data recorded by the audio sensors 116 of the audio broadcast by the electroacoustic transducers 114. The description of FIG. 2A below includes a detailed description of how the impulse response is determined by the response module 214. The high-pass filter module 216 processes the impulse response through a high-pass filter to derive a high-frequency component of the personalized impulse response for the user 102. Generally, a high-pass filter is an electronic filter that passes signals with a frequency higher than a cutoff threshold frequency and attenuates signals with frequencies lower than the cutoff threshold frequency. The amount of attenuation for each frequency can be adjusted depending on the filter design as well as the output requirements (e.g., the type and configuration of the system employing a personalized transfer function determined from the personalized impulse response to render sound). In some cases, the high-pass filter is modeled as a linear time-invariant system.

In some implementations, the generator module 222 generates a 3D representation of the head of the user 102 based on image data and/or IMU data provided by the sensors 112. For example, the generator module 222 may be configured to generate the 3D representation of the head of the user 102 using a neural network. The matching module 224 compares the 3D head representation with corresponding head shapes in an impulse response dataset (e.g., a database of impulse response models collected from available datasets as well as previously measured/generated models) and selects a best-matching impulse response from the dataset based on selection criterion criteria (e.g., matching position points, matching size, matching shape, and the like). The low-pass filter module 226 processes the selected impulse response through a low-pass filter to derive a low-frequency component of the personalized impulse response for the user 102. Similar to the high-pass filter, a low-pass filter is an electronic filter that passes signals with a frequency lower than a cutoff threshold frequency and attenuates signals with frequencies higher than the cutoff threshold frequency.

Generally, low-frequency components include frequencies lower than the cutoff threshold frequency while high-frequency components include frequencies higher than the cutoff threshold frequency. In some implementations, the cutoff threshold frequency is determined or set based on the specific application of the generated personalized impulse response as well as the configuration of the device 110, the electroacoustic transducers 114, and the audio sensors 116. In some implementations, cutoff threshold frequency is set to a frequency (or range of frequencies) within the bounds of the frequency range for human hearing, from about 20 hertz (Hz) to about 20 kilohertz (kHz); however, the exact frequency response of the low-pass filter and the high-pass filter depend on the design of each filter.

As described above, the combiner module 230 is configured to combine the high-frequency component provided from the high-pass filter module 216 and the low-frequency component provided from the low-pass filter module 226 into the resulting personalized impulse response for the user 102. In some implementations, the low-frequency component models the shape of the head while the high-frequency component models the shape of the pinna. In some cases, because the pinna is more difficult to accurately model (and therefore actually select models from a database), the HRIR is generated (see the description of FIG. 2A) to model, for example, the pinna of the user 102.

FIG. 2B is a block diagram of an example architecture for the response module 214 described above with reference to FIG. 2A. As depicted, the example architecture includes compensation module 252, segmentation module 254, transform module 256, amplitude module 258, filter module 260, and direction module 262. In some implementations, the modules 252, 254, 256, 258, 260, and 262 are executed via an electronic processor of the device 110, depicted in at least FIG. 1. In some implementations, the modules 252, 254, 256, 258, 260, and 262 are provided via a back-end system (such as the back-end system 430 described below with reference to FIG. 4) and the device 110 is configured to communicate with the back-end system via a network (such as the communications network 410 described below with reference to FIG. 4).

The compensation module 252 processes the audio data (e.g., signal) recorded by the audio sensors 116 to compensate for the amplitude response of the electroacoustic transducers 114 and the audio sensors 116. For example, in some implementations, the compensation module 252 determines the amplitude response of the electroacoustic transducers 114 and the audio sensors 116 based on information provided in a respective datasheet or a calibration procedure where, for example, the user 102 plays sound (e.g., white noise) from the electroacoustic transducers 114 at close distance (e.g., within a few feet) to the audio sensors 116. The inverse amplitude response of the electroacoustic transducers 114 (e.g., equalizing the transducer to provide a flat response across the frequency spectrum) and the audio sensors 116 is then determined based on the amplitude response. In some cases, the compensation module 252 does not compensate for the lower-frequency portion.

The segmentation module 254 segments the compensation signal into overlapping frames of appropriate length and step-size and the transform module 256 computes the integral transform (e.g., a fast Fourier transform [FFT]) for each frame (i.e., generating FFT frames). In some cases, the transform module 256 computes a short-term Fourier transform (STFT) for analyzing signals whose frequency content changes over time. In some examples, for each of the FFT frames, the amplitude module 258 computes an amplitude-response and the filter module 260 derives the minimum-phase filter from each of the amplitude responses. A minimum phase filter (e.g., an analog filter) can be configured to yield variable phase shifting with frequency. In control theory and signal processing, a linear, time-invariant system is minimum-phase when the system and its inverse are causal and stable. The difference between a minimum-phase and a general transfer function is that a minimum-phase system has the poles and zeros of its transfer function in the left half of the s-plane representation (in discrete time, respectively, inside the unit circle of the z plane).

The direction module 262 processes the position data provided by the position module 212 (see FIG. 2A) to add position labels (e.g., related to the direction and distance of the source of the audio) to the derived minimum-phase filters to form the HRIR, which is provided to the high-pass filter module 216 (see FIG. 2A) to derive the high-frequency component of the personalized impulse response for the user 102.

FIG. 3A is a block diagram of an example architecture 300 for the described audio signal personalization system. The example architecture 300 can be employed for the computation of a personalized transfer function by performing a best fit of the shape of a user's physical characteristics (e.g., the user's head and pinnae shape) with a dataset of HAT models, which includes scanned geometry of a human head and torso, and respective measured or computed HRTFs. At least one technical advantage provided via the example architecture 300 is that a personalized HRTF can be determined with a small dataset (even a dataset with just a single HAT model) but becomes more accurate as the size of the dataset increases.

As depicted, the example architecture 300 includes head function module 310, pinnae function module 320, HAT model datastore 340, and combiner module 330. The head function module 310 selects and scales an HAT model from the HAT model datastore 340 with the closed shape to a 3D model of a user's head (e.g., user's 102 head 106 described above with reference to FIG. 1), which is generated from sensor data (e.g., images) collected from a device (e.g., the device 110 described above with reference to FIG. 1). In some implementations, a scaling factor to match the head-size of the HAT model to the user's head is computed.

Similarly, the pinnae function module 320 selects and scales an HAT model from the HAT model datastore 340 with the closed shape to a 3D model of the user's pinnae (e.g., a user's 102 pinnae 104 described above with reference to FIG. 1), which is generated from the sensor data collected from the device. In some implementations, a scaling factor to match the pinnae-size of the HAT model to the user's pinnae is computed. In some implementations, the corresponding HRTFs of the selected HAT models are modified based on the respective scaling factors.

The combiner module 330 combines the modified HRTFs to derive the personalized HRTFs for the user. For example, in some implementations the combiner module 330 processes the modified head HRTF through a low-pass filter and the modified pinnae HRTF through a high-pass filter to form the low-frequency component and high-frequency component of a personalized HRTF for the user. Audio can then be generated based on the personalized HRTF and provided to the user to create an immersive and accurate spatial-audio experience.

As depicted in FIG. 3A, the head function module 310 (also can be referred to as a function module or as a first function module) includes head construction module 312 (also can be referred to as a construction module or as a first construction module), head selection module 314 (also can be referred to as a selection module or as a first selection module), head scaling factor module 316 (also can be referred to as a scaling factor module or as a first scaling factor module), and head frequency warping module 318 (also can be referred to as a frequency warping module or as a first frequency warping module) and the pinnae function module 320 (also can be referred to as a function module or as a second function module) includes pinnae construction module 322 (also can be referred to as a construction module or as a second construction module), pinnae selection module 324 (also can be referred to as a selection module or as a second selection module), pinnae scaling factor module 326 (also can be referred to as a scaling factor module or as a second scaling factor module), and pinnae frequency warping module 328 (also can be referred to as a frequency warping module or as a second frequency warping module).

In some implementations, the modules 310, 312, 314, 316, 318, 320, 322, 324, 326, 328, and 330 (or at least one module thereof is) are executed via an electronic processor of a device, such as the device 110 described above with reference to FIG. 1 or computing device 610 described below with reference to FIG. 6. In some implementations, the modules 310, 312, 314, 316, 318, 320, 322, 324, 326, 328, and 330 (or at least one module thereof is) are provided via a back-end system, such as the back-end system 430 described below with reference to FIG. 4, and the device (e.g., device 110 or computing device 610) is configured to communicate with the back-end system via a network, such as the communications network 410 described below with reference to FIG. 4.

In some implementations, the head construction module 312 generates a 3D model of the user's head based on received sensor data. In some implementations, the head construction module 312 receives the sensor data collected from the one or more sensors 112 as described above with reference to FIG. 1. The sensor data may include, for example, red, green, blue (RGB) and depth images of the user's 102 head 106 (i.e., a first physical characteristic). In some implementations, key-points for both left and right ears of the user 102 are extracted and estimated in the global frame of motion tracking. These key-points can be used to formulate ear and head (e.g., the center of the head) coordinates. In some examples, a position of the head includes a center point that is determined based on a mid-point between the ear openings. In some implementations, the head construction module 312 generates a 3D representation of the head of the user 102 using a trained neural network. In some implementations, the head construction module 312 generates a 3D representation of the head of the user 102 using a Multi-View Stereo approach that employs multiple images of a scene to estimate the depth information for each pixel, creating a dense 3D point cloud. The pinnae construction module 322 described below may employ similar techniques to construct a 3D representation of the pinnae of the user.

Apart from using a neural network, we can also use the Multi-View Stereo approach: This approach uses multiple images of a scene to estimate the depth information for each pixel, creating a dense 3D point cloud.

In some implementations, the head selection module 314 compares the 3D user head model to HAT models in the HAT model datastore 340 and selects, based on at least one selection criterion, the HAT model (and respective HRTF) having the most closely matching shape (referred to herein as ‘HAT model A’). In some cases, the at least one selection criterion is tailored to focus on matching shape rather than the size with the user's head (and pinnae as described below) because the best matching, according to shape, HAT model can be scaled to match the user's head (and pinnae).

In an example implementation, the volume space between the 3D models of the user's head (and/or pinnae) and the HAT models in the HAT datastore 340 is minimized using optimization variables. One example of such optimization variables includes: origin of the HAT model: xₒ, yₒ, zₒ; rotation of HAT model about the origin: θₒ, ϕₒ; and a scaling factor of HAT model: ρ_{HAT}. Using the optimization variables the optimization problem can be framed as a minimization of volume space between the heads (and/or pinnae) of the user and HAT models using xₒ, yₒ, zₒ, θₒ, ϕₒ and ρ_{HAT} In the example implementation, the HAT model with the smallest volume space is selected.

The head scaling factor module 316 determines a scaling factor to match the head-size of HAT model A with the 3D model of the user head. In some implementation, the optimization approach use by the head selection module 314 (and pinnae selection module 324) also provides the optimal scaling factor ρ_{HAT} as a by-product; however, for clarity, FIG. 3A depicts this computation by the head scaling factor module 316 (and the pinnae scaling factor module 326) separately.

The head frequency warping module 318 adjusts the HRTF associated with HAT model A via frequency warping based on the determined scaling factor to account for the change in the scaling. In some implementations, the head frequency warping module 318 adjusts the HRTF associated with HAT model A by warping the frequency of the HRTF proportionally to the scaling factor. Put another way, when the scaling factor is less than unity, a “stretched” frequency-warping is applied, and when the scaling factor is greater than unity, a “compressed” frequency-warping is applied. In some implementations, frequency warping includes transformation of the frequency spectrum. For example, the frequency spectrum of the audio signal can be either compressed or expanded (e.g., in a non-linear manner) across the frequency axis. In some implementations, frequency warping is applied using the phase vocoder scheme, which employs a short-time Fourier transform (STFT) analysis-modify-synthesis loop for time-scaling signals by means of using different time steps for STFT analysis and synthesis.

Generally, the pinnae function module 320 determines a warped HRTF (for the user's pinnae) in a similar manner to the head function module 310. In some implementations, the pinnae construction module 322 generates a 3D model of the user's pinnae based on collected sensor data. In some implementations, the pinnae construction module 322 receives the sensor data collected from the one or more sensors 112 as described above with reference to FIG. 1. The sensor data may include, for example, RGB and depth images of the user's 102 pinnae 104 (i.e., a second physical characteristic). In some cases, the same or somewhat overlapping sensor data is used in both the head construction module 312 and the pinnae construction module 322. In other cases, these modules use different sensor data collected for either the head or the pinnae of the user.

In some implementations, the pinnae selection module 324 compares the 3D user pinnae model to HAT models in the HAT model datastore 340 and selects, based on at least one selection criterion, the HAT model (and respective HRTF) having the most closely matching shape (referred to herein as ‘HAT model B’). In some cases, the at least one selection criterion is tailored to focus on matching shape rather than the size with the user's pinnae because the best matching HAT model can be scaled to match the user's pinnae.

The pinnae scaling factor module 326 determines a scaling factor to match the pinnae-size of HAT model B with the 3D model of the user pinnae. The pinnae frequency warping module 328 adjusts the HRTF associated with HAT model B via frequency warping based on the determined scaling factor to account for the change in the scaling factors. In some implementations, the pinnae frequency warping module 328 adjusts the HRTF associated with HAT model B by warping the frequency of the HRTF proportionally to the scaling factor.

The combiner module 330 combines the modified (e.g., warped) HRTFs to derive the personalized HRTFs for the user. FIG. 3B depicts an implementation of the combiner module 330 that applies a low-pass filter to the modified HRTF associated with model A (provided via the head function module 310) and a high-pass filter to the modified HRTF associated with model B (provided via the pinnae function module 320). The low-pass filter is applied to the modified HRTF scaled based on the 3D model of the user's head and the high-pass filter is applied to the modified HRTF scaled based on the 3D model of the user's pinnae because a person's head (and torso) primarily affects the lower frequencies of audio signals while a person's pinnae affect the higher frequencies.

The example combiner module 330 implementation depicted in FIG. 3B includes low-pass filter module 332, high-pass filter module 334, and frequency combiner module 336. The high-pass filter module 334 processes the modified (warped) HRTF associated with model B provided via the pinnae function module 320 through a high-pass filter to derive a high-frequency component of the personalized transfer function for the user 102.

Generally, a high-pass filter is an electronic filter that passes signals with a frequency higher than a cutoff threshold frequency (e.g., around 3 kilohertz (kHz)) and attenuates signals with frequencies lower than the cutoff threshold frequency. The amount of attenuation for each frequency can be adjusted depending on the filter design as well as the output requirements (e.g., the type and configuration of the system employing a personalized transfer function to render sound). In some cases, the high-pass filter is modeled as a linear time-invariant system.

The low-pass filter module 332 processes the modified (warped) HRTF associated with model A provided via the head function module 310 through a low-pass filter to derive a low-frequency component of the personalized transfer function for the user 102. Similar to the high-pass filter, a low-pass filter is an electronic filter that passes signals with a frequency lower than the cutoff threshold frequency and attenuates signals with frequencies higher than the cutoff threshold frequency.

Generally, the low-frequency components include frequencies lower than the cutoff threshold frequency while the high-frequency components include frequencies higher than the cutoff threshold frequency. In some implementations, the cutoff threshold frequency is determined or set based on the specific application of the generated personalized impulse response as well as the configuration of the device 110. In some implementations, cutoff threshold frequency is set to a frequency (or range of frequencies) within the bounds of the frequency range for human hearing, from about 20 hertz (Hz) to about 20 kilohertz (kHz); however, the exact frequency response of the low-pass filter and the high-pass filter depend on the design of each filter.

The frequency combiner module 336 is configured to combine the high-frequency component provided from the high-pass filter module 334 and the low-frequency component provided from the low-pass filter module 332 into the resulting personalized transfer function for the user 102. In some implementations, the modules 332, 334, and 336 (or at least one module thereof is) are executed via an electronic processor of a device, such as the device 110 described above with reference to FIG. 1 or computing device 610 described below with reference to FIG. 6. In some implementations, the modules 332, 334, and 336 (or at least one module thereof is) are provided via a back-end system, such as the back-end system 430 described below with reference to FIG. 4, and the device (e.g., device 110 or computing device 610) is configured to communicate with the back-end system via a network, such as the communications network 410 described below with reference to FIG. 4.

FIG. 4 depicts an example environment 400 that can be employed to execute implementations of the present disclosure. The example environment 400 includes computing devices 402, 404, 406, 408; a back-end system 430, and a communications network 410. The communications network 410 may include wireless and wired portions. In some cases, the communications network 410 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 410 may also include future developed networks. In some implementations, the communications network 410 includes the Internet, an intranet, an extranet, or an intranet and/or extranet that is in communication with the Internet. In some implementations, the communications network 410 includes a telecommunication or a data network.

In some implementations, the communications network 410 connects web sites, devices (e.g., the computing devices 402, 404, 406, and 408) and back-end systems (e.g., the back-end system 430). In some implementations, the communications network 410 can be accessed over a wired or a wireless communications link. For example, mobile computing devices (e.g., the computing device 402 can be a smartphone device and the computing device 406 can be a tablet device), can use a cellular network to access the communications network 410. In some examples, the users 422, 424, 426, and 428 interact with the system through a graphical user interface (GUI) (e.g., the user interface 625 described below with reference to FIG. 6) or client application that is installed and executing on their respective computing devices 402, 404, 406, or 408.

In some examples, the computing devices 402, 404, 406, and 408 provide viewing data (e.g., a prompt move the respective device while the device broadcasts audio) to screens with which the users 422, 424, 426, and 426, can interact. In some examples, the computing devices 402, 404, 406, and 408 broadcast and record audio signals and then provide the recorded signals to the back-end system 430, which is configured to determine a personalized impulse response according to implementations of the present disclosure. In some examples, the computing devices 402, 404, 406, and 408 are configured to determine a personalized impulse response and provide audio signals generated with the personalized impulse response (or the related personalize transfer function) to the respective users 422, 424, 426, and 426 according to implementations of the present disclosure.

In some cases, the computing devices 402, 404, 406, and 408 are configured to determine a personalized impulse response for multiple users according to implementations of the present disclosure. In such cases, the computing devices 402, 404, 406, and 408 may be configured to provide an audio stream (e.g., to headphones or a loudspeaker) generated based on the user's personalized impulse response or personalized transfer function. In some cases, the computing devices 402, 404, 406, and 408 may be configured to simultaneously provide audio signals generated for multiple users based on the user's respective personalized impulse response. For example, the computing devices 402, 404, 406, and 408 may be configured to provide a first audio signal to a first user (e.g., via a first pair of connected headphones) generated based on a first personalized impulse response associated with the first user while also providing a second audio signal to a second user (e.g., via a second pair of connected headphones) generated based on a second personalized impulse response associated with the second user.

In some cases, the computing devices 402, 404, 406, and 408 are configured to determine a single impulse response or a single transfer function for multiple users according to implementations of the present disclosure. In such cases, the computing devices 402, 404, 406, and 408 are configured provide instructions to move the device in a similar manner described above with reference to FIG. 1; however, the captured the audio data, video data, and/or IMU data includes information relates to more than one individual and/or their position relative to one other and/or other objects in the space in a particular environment. For example, the individuals may take scans based on how they most often sit in a room when listening to an audio system. In such cases, the computing devices 402, 404, 406, and 408 may be configured to generate an audio stream based on the single impulse response, which may then be provided to, for example, the audio system (e.g., via the communications network 410 or directly via BLUETOOTH).

In some implementations, the computing devices 402, 404, 406 and 408 are substantially similar to the computing device 610 described below with reference to FIG. 6. The computing devices 402, 404, 406, and 408 may include (e.g., may each include) any appropriate type of computing device, such as a desktop computer, a laptop computer, a handheld computer, a tablet computer, a personal digital assistant (PDA), an AR/VR/XR device, a cellular telephone, a network appliance, a camera, a smartphone, an enhanced general packet radio service (EGPRS) mobile phone, a media player, a navigation device, an email device, a game console, or an appropriate combination of any two or more of these devices or other data processing devices.

Four computing devices 402, 404, 406 and 408 are depicted in FIG. 4 for simplicity. In the depicted example environment 400, the computing device 402 is depicted as a smartphone, the computing device 404 is depicted as a tablet-computing device, the computing device 406 is depicted as a desktop computing device, and the computing device 408 is depicted as an AR/VR/XR device. It is contemplated, however, that implementations of the present disclosure can be realized with any of the appropriate computing devices, such as those mentioned previously. Moreover, implementations of the present disclosure can employ any number of devices.

In some implementations, the back-end system 430 includes at least one server device 432 and optionally, at least one data store 434. In some implementations, the server device 432 is substantially similar to computing device 610 depicted below with reference to FIG. 6. In some implementations, the server device 432 is a server-class hardware type device. In some implementations, the back-end system 430 includes computer systems using clustered computers and components to function as a single pool of seamless resources when accessed through the communications network 410. For example, such implementations may be used in data center, cloud computing, storage area network (SAN), and network attached storage (NAS) applications. In some implementations, the back-end system 430 is deployed using a virtual machine(s).

In some implementations, the data store 434 is a repository for persistently storing and managing collections of data. Example data stores that may be employed within the described system include data repositories, such as a database as well as simpler store types, such as files, emails, and so forth. In some implementations, the data store 434 includes a database. In some implementations, a database is a series of bytes or an organized collection of data that is managed by a database management system (DBMS).

In some implementations, the back-end system 430 hosts one or more computer-implemented services provided by the described system with which users 422, 424, 426, and 426 can interact using the respective computing devices 402, 404, 406, and 408. For example, in some implementations, the back-end system 430 is configured to determine a personalized impulse response or a personalized transfer function according to implementations of the present disclosure.

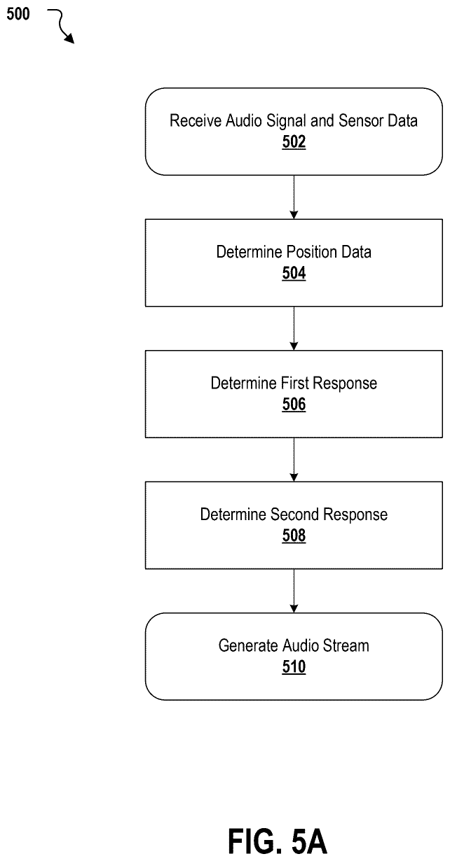

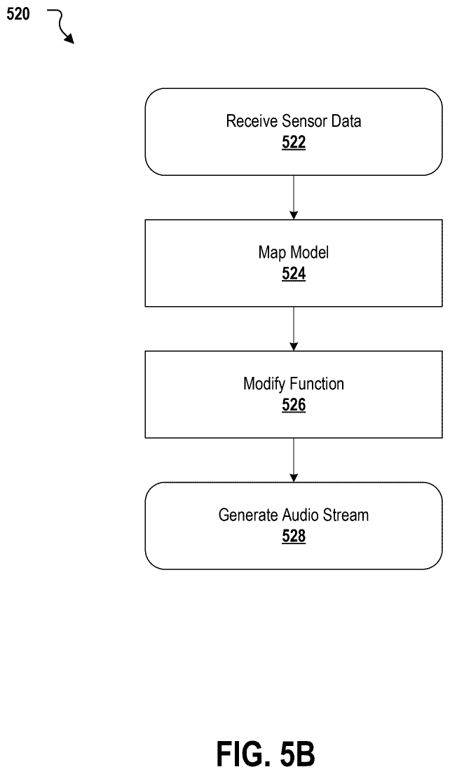

FIG. 5A and 5B each depict a flowchart of an example process 500 and 520 respectively that can be implemented by implementations of the present disclosure. The example processes 500 and 520 can be implemented by systems and components described with reference to FIGS. 1-4 and 6. The example process 500 generally shows in more detail how a personalized impulse response is determined or updated based on a recorded audio signal and sensor data (e.g., video and/or ICU data). The example process 520 generally shows in more detail how a personalized transfer function is determined or updated based on a sensor data (e.g., video and/or ICU data).

For clarity of presentation, the description that follows generally describes the example processes 500 and 520 in the context of FIGS. 1-4 and 6. However, it will be understood that the processes 500 and 520 may be performed, for example, by any other suitable system, environment, software, and hardware, or a combination of systems, environments, software, and hardware as appropriate. In some implementations, various operations of the processes 500 and 520 can be run in parallel, in combination, in loops, or in any order.

For process 500 depicted in FIG. 5A, at 502, an audio signal and sensor data captured while a sound is broadcast from an audio source are received. In some implementations, the sensor data is captured by a camera and an inertial measurement unit sensor of a mobile device (e.g., the computing devices 402, 404, 406, or 408 depicted in FIG. 4). In some implementations, the mobile device comprises the audio source.

From 502, the process 500 proceeds to 504 where position data for the audio source is determined based on the sensor data. In some implementations, the position data for the audio source is determined with respect to a head of a user based on the sensor data. In some implementations, the position data includes a direction and a relative distance of the audio source with respect to a center of the head of the user, the center of the head of the user including a mid-point between ear openings of the user.

From 504, the process 500 proceeds to 506 where a first response is determined based on the audio signal and the position data. In some implementations, the first response characterizes a response of the audio signal as a function of time. In some implementations, the first response is determined by: determining a frame from the audio signal; determining a transform frame by applying a transform for the frame; determining an amplitude response for the transform frame; determining a phase filter from the amplitude response; and applying at least one position label, based on the position data, to the phase filter to form the first response. In some implementations, the phase filter is a minimum-phase filter.

In some implementations, the frame is a first frame. In some implementations, the first response is determined by: determining a second frame from the audio signal, where in the second frame includes data that overlaps data in the first frame. In some implementations, the transform is a fast Fourier transform. In some implementations, the audio signal is captured by a microphone. In some implementations, at least one position label is related to a direction and a distance of the audio source in relation to the microphone. In some implementations, before the frame is determined based on the audio signal, an amplitude response of the audio source in the audio signal and the microphone is compensated for.

From 506, the process 500 proceeds to 508 where a second response is determined by applying a filter to the first response. In some implementations, the filter includes an electronic filter that passes signals with a frequency higher than a cutoff threshold frequency and attenuates signals with frequencies lower than the cutoff threshold frequency. In some implementations, the filter is a first filter. In some implementations, a high-frequency component of the second response is determined by applying the first filter to the second response, and a low-frequency component of the second response is determined by applying a second filter to a selected impulse response.

In some implementations, the second response is associated with a user. In some implementations, a three-dimensional representation of a head is determined based on the sensor data, and the selected impulse response is selected from a dataset based on the three-dimensional representation and a selection criterion. In some implementations, the second filter includes an electronic filter that passes signals with a frequency lower than a cutoff threshold frequency and attenuates signals with frequencies higher than the cutoff threshold frequency. In some implementations, the second response is associated with an object. In some implementations, the second response is associated with only an object. In some implementations, the second response can be associated with an object and a user. In some implementations, the object can include a small object, a structure, a portion of a structure, multiple objects that function together as a single object, and/or so forth.

From 508, the process 500 proceeds to 510 where an audio stream is generated based on the second response. In some implementations, the second response is a personalized impulse response for the user. In some implementations, the characteristic (e.g., physical characteristic) includes the head of the user. In some implementations, the audio stream is configured for a characteristic of the user. In some implementations, the audio stream configured for the characteristic of the user is generated based on the personalized impulse response. For example, the generated audio stream may include music or other audio that is broadcast via an audio source (e.g., a loudspeaker connected to one of the computing devices 402, 404, 406, or 408 depicted in FIG. 4) to the user (e.g., the respective users 422, 424, 426, or 426 depicted in FIG. 4).

In some implementations, a transform is applied to the personalized impulse response to generate a personalized transfer function, and the audio stream configured for the characteristic of the user is generated based on the personalized transfer function. In some implementations, the transform is a Z-transform or a Laplace transform. In some implementations, at least one of the first response or the second response is a head-related impulse response. From 510, the process 500 ends or repeats.

For process 520 depicted in FIG. 5B, at 522, sensor data corresponding with a physical characteristic of a user is received. In some implementations, the sensor data is captured by an imagine sensor (e.g., a camera) of a mobile device (e.g., the device 110 described above with reference to FIG. 1 and/or the computing devices 402, 404, 406, or 408 described above with reference to FIG. 4). In some implementations, the physical characteristic of the user is related to the head of the user or at least one pinna of the user. In some implementations, the sensor data is produced by an imaging device coupled to a mobile device. In some implementations, the sensor data are images captured by the imaging device while the user moves the mobile device around the head or the at least one pinna of the user based on a prompt provided via a display associated with the mobile device.

From 522, the process 520 proceeds to 524 where a model is scaled to the physical characteristic. In some implementations, the model is scaled to the physical characteristic by determining a scaling factor by scaling the model to match the physical characteristic. In some implementations, a representation of the physical characteristic is generated based on the sensor data. In some implementations, the model is selected from a plurality of models based on the representation and a selection criterion. In some implementations, the representation is a 3D representation of the physical characteristic. In some implementations, the model is a head-and-torso model.

In some implementations, the selection criterion is tailored to match the shape of the physical characteristic more than a size of the physical characteristic. In some implementations, the model is selected by determining a volume of space between the representation of the physical characteristic and the plurality of models. In some implementations, the selection criterion includes selecting a model of the plurality of models having the smallest volume of space between the representation of the physical characteristic. In some implementations, the volume of space is determined using a plurality of optimization variables that include an origin, a rotation about the origin, and the scaling factor. In some implementations, the model is selected by determining the scaling factor.

From 524, the process 520 proceeds to 526 where a function representing an audio response is modified based on the scaled model to produce a modified function. In some implementations, the function is modified by modifying the function based on the scaling factor. In some implementations, the function is modified by warping the frequency of the function proportionally to the scaling factor. In some implementations, the function is a head related transfer function associated with the model. In some implementations, the modified function is a head related transfer function personalized for the user. In some implementations, the sensor data includes environment data corresponding to an environment around the user. In some implementations, the function is modified based on the environment data.

From 526, the process 520 proceeds to 528 where an audio stream is generated based on the modified function. In some implementations, the audio stream is provided to a user device or an audio output device such as headphones or a loudspeaker(s).

In some implementations, the physical characteristic is a first physical characteristic, the model is a first model, the function is a first function, the audio response is a first audio response, and the modified function is a modified first function. In some implementations, the sensor data corresponds with a second physical characteristic of a user.

In some implementations, a second model is scaled to the second physical characteristic. In some implementations, a second function (e.g., a transfer function) representing a second audio response is modified based on the scaled second model to produce a modified second function. In some implementations, the modified first function and the modified second function are combined to form a combined function (e.g., a combined transfer function). In some implementations, the audio stream is generated based on the combined function.

In some implementations, the modified first function and the modified second function are combined to form the combined function by determining a high-frequency component by applying a low-frequency filter to the modified first function, determining a low-frequency component by applying a high-frequency filter to the modified second function, and combining the low-frequency component and the high-frequency component to form the combined function.

In some implementations, the low-frequency filter includes an electronic filter that passes signals with a frequency lower than a cutoff threshold frequency and attenuates signals with frequencies higher than the cutoff threshold frequency. In some implementations, the high-frequency filter includes an electronic filter that passes signals with a frequency higher than a cutoff threshold frequency and attenuates signals with frequencies lower than the cutoff threshold frequency. In some implementations, the cutoff threshold frequency is set to about 3 kilohertz. From 528, the process 520 ends or repeats.

FIG. 6 depicts an example computing system 600 that includes a computer or computing device 610 that can be programmed or otherwise configured to implement systems or methods of the present disclosure. For example, the computing device 610 can be programmed or otherwise configured to implement the processes 500 and/or 520. In some cases, the computing device 610 includes an operating system configured to perform executable instructions. The operating system is, for example, software, including programs and data that manages the device's hardware and provides services for execution of applications.

In the depicted implementation, the computer or computing device 610 includes an electronic processor (also “processor” and “computer processor” herein) 612, such as a central processing unit (CPU) or a graphics processing unit (GPU), which is optionally a single core, a multi core processor, or a plurality of processors for parallel processing. The depicted implementation also includes memory 617 (e.g., random-access memory, read-only memory, flash memory), storage unit 614 (e.g., hard disk or flash), communication interface module 615 (e.g., a network adapter or modem) for communicating with one or more other systems, and peripheral devices 616, such as cache, other memory, data storage, microphones, speakers, and the like. In some implementations, the memory 617, storage unit 614, communication interface module 615 and peripheral devices 616 are in communication with the electronic processor 612 through a communication bus (shown as solid lines), such as a motherboard. In some implementations, the bus of the computing device 610 includes multiple buses. The above-described hardware components of the computing device 610 can be used to facilitate, for example, an operating system and operations of one or more applications executed via the operating system. For example, a virtual representation of space may be provided via the user interface 625. In some implementations, the computing device 610 includes more or fewer components than those illustrated in FIG. 6 and performs functions other than those described herein.

In some implementations, the memory 617 and storage unit 614 include one or more physical apparatuses used to store data or programs on a temporary or permanent basis. In some implementations, the memory 617 is volatile memory and can use power to maintain stored information. In some implementations, the storage unit 614 is non-volatile memory and retains stored information when the computer is not powered. In further implementations, memory 617 or storage unit 614 is a combination of devices such as those disclosed herein. In some implementations, memory 617 or storage unit 614 is distributed across multiple machines such as a network-based memory or memory in multiple machines performing the operations of the computing device 610.

In some cases, the storage unit 614 is a data storage unit or data store for storing data. In some instances, the storage unit 614 stores files, such as drivers, libraries, and saved programs. In some implementations, the storage unit 614 stores data received by the device (e.g., audio data). In some implementations, the computing device 610 includes one or more additional data storage units that are external, such as located on a remote server that is in communication through a network (e.g., the communications network 410 described above with reference to FIG. 4).

In some implementations, platforms, systems, media, and methods as described herein are implemented by way of machine or computer executable code stored on an electronic storage location (e.g., non-transitory computer readable storage media) of the computing device 610, such as, for example, on the memory 617 or the storage unit 614. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 612 is configured to execute the code. In some implementations, the machine executable or machine-readable code is provided in the form of software. In some examples, during use, the code is executed by the electronic processor 612. In some cases, the code is retrieved from the storage unit 614 and stored on the memory 617 for ready access by the electronic processor 612. In some situations, the storage unit 614 is precluded, and machine-executable instructions are stored on the memory 617.

In some cases, the electronic processor 612 is a component of a circuit, such as an integrated circuit. One or more other components of the computing device 610 can be optionally included in the circuit. In some cases, the circuit is an application specific integrated circuit (ASIC) or a field programmable gate arrays (FPGAs). In some cases, the operations of the electronic processor 612 can be distributed across multiple machines (where individual machines can have one or more processors) that can be coupled directly or across a network.

In some cases, the computing device 610 is optionally operatively coupled to a communications network, such as the communications network 410 described above with reference to FIG. 4, via the communication interface module 615, which may include digital signal processing circuitry. Communication interface module 615 may provide for communications under various modes or protocols, such as global system for mobile (GSM) voice calls, short message/messaging service (SMS), enhanced messaging service (EMS), or multimedia messaging service (MMS) messaging, code-division multiple access (CDMA), time division multiple access (TDMA), wideband code division multiple access (WCDMA), CDMA2000, or general packet radio service (GPRS), among others. Such communication may occur, for example, through a transceiver. In addition, short-range communication may occur, such as using a BLUETOOTH, WI-FI, or other such transceiver.

In some cases, the computing device 610 includes or is in communication with one or more output devices 620. In some cases, the output device 620 includes a display to send visual information to a user. In some cases, the output device 620 is a touch sensitive display that combines a display with a touch sensitive element that is operable to sense touch inputs as and functions as both the output device 620 and the input device 630. In still further cases, the output device 620 is a combination of devices such as those disclosed herein. In some cases, the output device 620 displays a user interface 625 generated by the computing device.

In some cases, the computing device 610 includes or is in communication with one or more input devices 630 that are configured to receive information from a user. In some cases, the input device 630 is a keyboard. In some cases, the input device 630 is a keypad (e.g., a telephone-based keypad). In some cases, the input device 630 is a cursor-control device including, by way of non-limiting examples, a mouse, trackball, trackpad, joystick, game controller, or stylus. In some cases, as described above, the input device 630 is a touchscreen or a multi-touchscreen. In other cases, the input device 630 is a microphone to capture voice or other sound input. In other cases, the Input device 630 is an imaging device such as a camera. In still further cases, the input device is a combination of devices such as those disclosed herein.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 612. As such, it should be noted that a plurality of hardware and software-based devices, as well as a plurality of different structural components may be employed to implement various implementations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system.

It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

### Examples

The following paragraphs provide various examples of the implementations disclosed herein.

Example 1 is a method that includes receiving an audio signal and sensor data captured while a sound is broadcast from an audio source; determining position data for the audio source based on the sensor data; determining a first response based on the audio signal and the position data, the first response characterizing a response of the audio signal as a function of time; determining a second response by applying a filter to the first response; and generating an audio stream based on the second response.

Example 2 includes the subject matter of Example 1, and further includes determining the first response by: determining a frame from the audio signal and determining a transform frame by applying a transform for the frame.

Example 3 includes the subject matter of Example 1 or 2, and further includes determining the first response by: determining an amplitude response for the transform frame and determining a phase filter from the amplitude response.

Example 4 includes the subject matter of any of Examples 1-3, and further includes determining the first response by applying at least one position label, based on the position data, to the phase filter to form the first response.

Example 5 includes the subject matter of any of Examples 1-4, and further specifies that the phase filter is a minimum-phase filter.

Example 6 includes the subject matter of any of Examples 1-5, and further specifies that the frame is a first frame, and that the method further includes determining the first response by determining a second frame from the audio signal.

Example 7 includes the subject matter of any of Examples 1-6, and further specifies that the second frame includes data that overlaps data in the first frame.

Example 8 includes the subject matter of any of Examples 1-7, and further specifies that the transform is a fast Fourier transform.

Example 9 includes the subject matter of any of Examples 1-8, and further specifies that the audio signal is captured by a microphone.

Example 10 includes the subject matter of any of Examples 1-9, and further specifies that at least one position label is related to a direction and a distance of the audio source in relation to the microphone.

Example 11 includes the subject matter of any of Examples 1-10, and further includes before determining the frame based on the audio signal, compensating for an amplitude response of the audio source in the audio signal and the microphone.

Example 12 includes the subject matter of any of Examples 1-11, and further specifies that the filter includes an electronic filter that passes signals with a frequency higher than a cutoff threshold frequency and attenuates signals with frequencies lower than the cutoff threshold frequency.

Example 13 includes the subject matter of any of Examples 1-12, and further specifies that the filter is a first filter; and that the method further includes determining a high-frequency component of the second response by applying the first filter to the second response and determining a low-frequency component of the second response by applying a second filter to a selected impulse response.

Example 14 includes the subject matter of any of Examples 1-13, and further specifies that the second response is associated with a user.

Example 15 includes the subject matter of any of Examples 1-14, and further specifies that the audio stream is configured for a characteristic of the user.

Example 16 includes the subject matter of any of Examples 1-15, and further includes determining a three-dimensional representation of a head based on the sensor data and selecting the selected impulse response from a dataset based on the three-dimensional representation and a selection criterion.

Example 17 includes the subject matter of any of Examples 1-16, and further specifies that the second filter includes an electronic filter that passes signals with a frequency lower than a cutoff threshold frequency and attenuates signals with frequencies higher than the cutoff threshold frequency.

Example 18 includes the subject matter of any of Examples 1-17, and further includes determining the position data for the audio source with respect to a head of a user based on the sensor data.

Example 19 includes the subject matter of any of Examples 1-18, and further specifies that the position data includes a direction and a relative distance of the audio source with respect to a center of the head of the user, the center of the head of the user including a mid-point between ear openings of the user.

Example 20 includes the subject matter of any of Examples 1-19, and further specifies that the second response is a personalized impulse response for the user and the characteristic includes the head of the user.

Example 21 includes the subject matter of any of Examples 1-20, and further includes generating the audio stream configured for the characteristic of the user based on the personalized impulse response.

Example 22 includes the subject matter of any of Examples 1-21, and further includes applying a transform to the personalized impulse response to generate a personalized transfer function and generating the audio stream configured for the characteristic of the user based on the personalized transfer function.

Example 23 includes the subject matter of any of Examples 1-22, and further specifies that the transform is a Z-transform or a Laplace transform.

Example 24 includes the subject matter of any of Examples 1-23, and further specifies that at least one of the first response or the second response is a head-related impulse response.

Example 25 includes the subject matter of any of Examples 1-24, and further specifies that the sensor data is captured by a camera or an inertial measurement unit sensor of a mobile device that includes the audio source.

Example 26 includes the subject matter of any of Examples 1-25, and further specifies that the second response is associated with an object.

Example 27 includes a computer-readable medium storing instructions that when executed by an electronic processor cause the electronic processor to perform the method as described in any of the Examples 1-26.

Example 28 is a system that includes a computing device and an electronic processor coupled to the computing device. The computer includes an electroacoustic transducer configured to broadcast a sound, an imaging sensor, and an audio sensor. The electronic processor is configured to receive an audio signal from the audio sensor; receive sensor data form the imaging sensor, the audio signal and the sensor data captured while the electroacoustic transducer broadcast the sound; determine position data for the electroacoustic transducer based on the sensor data; determine a first response based on the audio signal and the position data, the first response characterizing a response of the audio signal as a function of time; determine a second response associated with a user by applying a filter to the first response; and generate an audio stream configured for a characteristic of the user based on the second response.

Example 29 includes the subject matter of Example 28 further specifies that the electronic processor is configured to determine the first response by: determining a frame from the audio signal and determining a transform frame by applying a transform for the frame.

Example 30 includes the subject matter of Example 28 or 29, and further specifies that the electronic processor is configured to determine the first response by: determining an amplitude response for the transform frame and determining a phase filter from the amplitude response.

Example 31 includes the subject matter of any of Examples 28-30, and further specifies that the electronic processor is configured to determine the first response by applying at least one position label, based on the position data, to the phase filter to form the first response.

Example 32 includes the subject matter of any of Examples 28-31, and further specifies that the phase filter is a minimum-phase filter.

Example 33 includes the subject matter of any of Examples 28-32, and further specifies that the frame is a first frame, and that the electronic processor is further configured to determine the first response by determining a second frame from the audio signal.

Example 34 includes the subject matter of any of Examples 28-33, and further specifies that the second frame includes data that overlaps data in the first frame.

Example 35 includes the subject matter of any of Examples 28-34, and further specifies that the transform is a fast Fourier transform.

Example 36 includes the subject matter of any of Examples 28-35, and further specifies that the audio signal is captured by a microphone.

Example 37 includes the subject matter of any of Examples 28-36, and further specifies that at least one position label is related to a direction and a distance of the audio source in relation to the microphone.

Example 38 includes the subject matter of any of Examples 28-37, and further specifies that the electronic processor is further configured to, before determining the frame based on the audio signal, compensate for an amplitude response of the audio source in the audio signal and the microphone.

Example 39 includes the subject matter of any of Examples 28-38, and further specifies that the filter includes an electronic filter that passes signals with a frequency higher than a cutoff threshold frequency and attenuates signals with frequencies lower than the cutoff threshold frequency.

Example 40 includes the subject matter of any of Examples 28-39, and further specifies that the filter is a first filter; and that the electronic processor is further configured to determine a high-frequency component of the second response by applying the first filter to the second response and determine a low-frequency component of the second response by applying a second filter to a selected impulse response.

Example 41 includes the subject matter of any of Examples 28-40, and further specifies that the second response is associated with a user.

Example 42 includes the subject matter of any of Examples 28-41, and further specifies that the audio stream is configured for a characteristic of the user.

Example 43 includes the subject matter of any of Examples 28-42, and further specifies that the electronic processor is further configured to determine a three-dimensional representation of a head based on the sensor data and select the selected impulse response from a dataset based on the three-dimensional representation and a selection criterion.

Example 44 includes the subject matter of any of Examples 28-43, and further specifies that the second filter includes an electronic filter that passes signals with a frequency lower than a cutoff threshold frequency and attenuates signals with frequencies higher than the cutoff threshold frequency.

Example 45 includes the subject matter of any of Examples 28-44, and further specifies that the electronic processor is further configured to determine the position data for the audio source with respect to a head of a user based on the sensor data.

Example 46 includes the subject matter of any of Examples 28-45, and further specifies that the position data includes a direction and a relative distance of the audio source with respect to a center of the head of the user, the center of the head of the user including a mid-point between ear openings of the user.

Example 47 includes the subject matter of any of Examples 28-46, and further specifies that the second response is a personalized impulse response for the user and the characteristic includes the head of the user.

Example 48 includes the subject matter of any of Examples 28-47, and further specifies that the electronic processor is further configured to generate the audio stream configured for the characteristic of the user based on the personalized impulse response.

Example 49 includes the subject matter of any of Examples 28-48, and further specifies that the electronic processor is further configured to apply a transform to the personalized impulse response to generate a personalized transfer function and generate the audio stream configured for the characteristic of the user based on the personalized transfer function.

Example 50 includes the subject matter of any of Examples 28-49, and further specifies that the transform is a Z-transform or a Laplace transform.

Example 51 includes the subject matter of any of Examples 28-50, and further specifies that at least one of the first response or the second response is a head-related impulse response.

Example 52 includes the subject matter of any of Examples 28-51, and further specifies that the sensor data is captured by a camera or an inertial measurement unit sensor of a mobile device that includes the audio source.

Example 53 includes the subject matter of any of Examples 27-52, and further specifies that the second response is associated with an object.

Example 54 is a method that includes receiving sensor data corresponding with a physical characteristic of a user; scaling a model to the physical characteristic; modifying a function, representing an audio response, based on the scaled model to produce a modified function; and generating an audio stream based on the modified function.

Example 55 includes the subject matter of Example 54, and further specifies that scaling the model to the physical characteristic includes determining a scaling factor by scaling the model to match the physical characteristic.

Example 56 includes the subject matter of Example 54 or 55, and further specifies that modifying the function includes modifying the function based on the scaling factor.

Example 57 includes the subject matter of any of Examples 54-56, and further specifies that modifying the function includes warping a frequency of the function proportionally to the scaling factor.

Example 58 includes the subject matter of any of Examples 54-57, and further includes providing the audio stream to a user device or an output audio device such as a loudspeaker or headphones.

Example 59 includes the subject matter of any of Examples 54-58, and further includes generating, based on the sensor data, a representation of the physical characteristic.

Example 60 includes the subject matter of any of Examples 54-59, and further includes selecting the model from a plurality of models based on the representation and a selection criterion.

Example 61 includes the subject matter of any of Examples 54-60, and further specifies that the representation is a 3D representation of the physical characteristic.

Example 62 includes the subject matter of any of Examples 54-61, and further specifies that the selection criterion is tailored to match a shape of the physical characteristic more than a size of the physical characteristic.

Example 63 includes the subject matter of any of Examples 54-62, and further specifies that selecting the model includes determining a volume of space between the representation of the physical characteristic and the plurality of models.

Example 64 includes the subject matter of any of Examples 54-63, and further specifies that the selection criterion includes selecting a model of the plurality of models having a smallest volume of space between the representation of the physical characteristic.

Example 65 includes the subject matter of any of Examples 54-64, and further specifies that the volume of space is determined using a plurality of optimization variables that include an origin, a rotation about the origin, and the scaling factor.

Example 66 includes the subject matter of any of Examples 54-65, and further specifies that selecting the model includes determining the scaling factor.

Example 67 includes the subject matter of any of Examples 54-66, and further specifies that the physical characteristic is a first physical characteristic, the model is a first model, the function is a first function, the audio response is a first audio response, and the modified function is a modified first function.

Example 68 includes the subject matter of any of Examples 54-67, and further specifies that the sensor data corresponds with a second physical characteristic of a user.

Example 69 includes the subject matter of any of Examples 54-68, and further includes scaling a second model to the second physical characteristic.

Example 70 includes the subject matter of any of Examples 54-69, and further includes modifying a second function, representing a second audio response, based on the scaled second model to produce a modified second function.

Example 71 includes the subject matter of any of Examples 54-70, and further includes combining the modified first function and the modified second function to form a combined function.

Example 72 includes the subject matter of any of Examples 54-71, and further specifies that generating the audio stream based on the modified function includes generating the audio stream based on the combined function.

Example 73 includes the subject matter of any of Examples 54-72, and further specifies that combining the modified first function and the modified second function to form the combined function includes determining a high-frequency component by applying a low-frequency filter to the modified first function.

Example 74 includes the subject matter of any of Examples 54-73, and further specifies that combining the modified first function and the modified second function to form the combined function includes determining a low-frequency component by applying a high-frequency filter to the modified second function.

Example 75 includes the subject matter of any of Examples 54-74, and further specifies that combining the modified first function and the modified second function to form the combined function includes combining the low-frequency component and the high-frequency component to form the combined function.

Example 76 includes the subject matter of any of Examples 54-75, and further specifies that the low-frequency filter includes an electronic filter that passes signals with a frequency lower than a cutoff threshold frequency and attenuates signals with frequencies higher than the cutoff threshold frequency.

Example 77 includes the subject matter of any of Examples 54-76, and further specifies that the high-frequency filter includes an electronic filter that passes signals with a frequency higher than a cutoff threshold frequency and attenuates signals with frequencies lower than the cutoff threshold frequency.

Example 78 includes the subject matter of any of Examples 54-77, and further specifies that the cutoff threshold frequency is set to about 3 kilohertz.

Example 79 includes the subject matter of any of Examples 54-78, and further specifies that the physical characteristic of the user is related to a head of the user or at least one pinna of the user.

Example 80 includes the subject matter of any of Examples 54-79, and further specifies that the sensor data is produced by an imaging device coupled to a mobile device.

Example 81 includes the subject matter of any of Examples 54-80, and further specifies that the sensor data are images captured by the imaging device while the user moves the mobile device around the head or the at least one pinna of the user based on a prompt provided via a display associated with the mobile device.

Example 82 includes the subject matter of any of Examples 54-81, and further specifies that the model is a head-and-torso model.

Example 83 includes the subject matter of any of Examples 54-82, and further specifies that the function is a head related transfer function associated with the model.

Example 84 includes the subject matter of any of Examples 54-83, and further specifies that the modified function is a head related transfer function personalized for the user.

Example 85 includes a computer-readable medium storing instructions that when executed by an electronic processor cause the electronic processor to perform the method as described in any of the Examples 54-84.

Example 86 is a system that includes a computing device and an electronic processor coupled to the computing device. The computing device includes an imaging sensor. The electronic processor is configured to: receive, from the imaging sensor, sensor data corresponding with a physical characteristic of a user; scale a model to the physical characteristic; modify a function, representing an audio response, based on the scaled model to produce a modified function; and provide an audio stream based on the modified function.

Example 87 includes the subject matter of Example 86, and further specifies the model is scaled to the physical characteristic by determining a scaling factor by scaling the model to match the physical characteristic.

Example 88 includes the subject matter of Example 86 or 87, and further specifies that the function is modified by modifying the function based on the scaling factor.

Example 89 includes the subject matter of any of Examples 86-88, and further specifies that the function is modified by warping a frequency of the function proportionally to the scaling factor.

Example 90 includes the subject matter of any of Examples 86-89, and further specifies that the electronic processor is configured to provide the audio stream to the user device or an output audio device such as a loudspeaker or headphones.

Example 91 includes the subject matter of any of Examples 86-90, and further specifies that the electronic processor is configured to generate, based on the sensor data, a representation of the physical characteristic.

Example 92 includes the subject matter of any of Examples 86-91, and further specifies that the electronic processor is configured to select the model from a plurality of models based on the representation and a selection criterion.

Example 93 includes the subject matter of any of Examples 86-92, and further specifies that the representation is a 3D representation of the physical characteristic.

Example 94 includes the subject matter of any of Examples 86-93, and further specifies that the selection criterion is tailored to match a shape of the physical characteristic more than a size of the physical characteristic.

Example 95 includes the subject matter of any of Examples 86-94, and further specifies that the electronic processor is configured to select the model by determining a volume of space between the representation of the physical characteristic and the plurality of models.

Example 96 includes the subject matter of any of Examples 86-95, and further specifies that the selection criterion includes selecting a model of the plurality of models having a smallest volume of space between the representation of the physical characteristic.

Example 97 includes the subject matter of any of Examples 86-96, and further specifies that the volume of space is determined using a plurality of optimization variables that include an origin, a rotation about the origin, and the scaling factor.

Example 98 includes the subject matter of any of Examples 86-97, and further specifies that the electronic processor is configured to select the model by determining the scaling factor.

Example 99 includes the subject matter of any of Examples 86-98, and further specifies that the physical characteristic is a first physical characteristic, the model is a first model, the function is a first function, the audio response is a first audio response, and the modified function is a modified first function.

Example 100 includes the subject matter of any of Examples 86-99 and further specifies that the sensor data corresponds with a second physical characteristic of a user.

Example 101 includes the subject matter of any of Examples 86-100, and further specifies that the electronic processor is configured to scale a second model to the second physical characteristic.

Example 102 includes the subject matter of any of Examples 86-101, and further specifies that the electronic processor is configured to modify a second function, representing a second audio response, based on the scaled second model to produce a modified second function.

Example 103 includes the subject matter of any of Examples 86-102, and further specifies that the electronic processor is configured to combine the modified first function and the modified second function to form a combined function.

Example 104 includes the subject matter of any of Examples 86-103, and further specifies that the audio stream is generated based on the combined function.

Example 105 includes the subject matter of any of Examples 86-104, and further specifies that the electronic processor is configured to combine the modified first function and the modified second function to form the combined function by determining a high-frequency component by applying a low-frequency filter to the modified first function.

Example 106 includes the subject matter of any of Examples 86-105, and further specifies that the electronic processor is configured to combine the modified first function and the modified second function to form the combined function by determining a low-frequency component by applying a high-frequency filter to the modified second function.

Example 107 includes the subject matter of any of Examples 86-106, and further specifies that the electronic processor is configured to combine the modified first function and the modified second function to form the combined function by combining the low-frequency component and the high-frequency component to form the combined function.

Example 108 includes the subject matter of any of Examples 86-107, and further specifies that the low-frequency filter includes an electronic filter that passes signals with a frequency lower than a cutoff threshold frequency and attenuates signals with frequencies higher than the cutoff threshold frequency.

Example 109 includes the subject matter of any of Examples 86-108, and further specifies that the high-frequency filter includes an electronic filter that passes signals with a frequency higher than a cutoff threshold frequency and attenuates signals with frequencies lower than the cutoff threshold frequency.

Example 110 includes the subject matter of any of Examples 86-109, and further specifies that the cutoff threshold frequency is set to about 3 kilohertz.

Example 111 includes the subject matter of any of Examples 86-110, and further specifies that the physical characteristic of the user is related to a head of the user or at least one pinna of the user.

Example 112 includes the subject matter of any of Examples 86-111, and further specifies that the sensor data are images captured by the imaging sensor while the user moves the computing device around the head or the at least one pinna of the user based on prompt provided via a display associated with the computing device.

Example 113 includes the subject matter of any of Examples 86-112, and further specifies that the model is a head-and-torso model.

Example 114 includes the subject matter of any of Examples 86-113, and further specifies that the function is a head related transfer function associated with the model.

Example 115 includes the subject matter of any of Examples 86-114, and further specifies that the modified function is a head related transfer function personalized for the user.

Example 116 is a method that includes modifying a function representing an audio response using on a model scaled to a physical characteristic of a user based on sensor data corresponding with the physical characteristic and generating an audio stream based on the modified function.

Example 117 includes the subject matter of Example 116, and further specifies that scaling the model to the physical characteristic includes determining a scaling factor by scaling the model to match the physical characteristic.

Example 118 includes the subject matter of Example 116 or 117, and further specifies that modifying the function includes modifying the function based on the scaling factor.

Example 119 includes the subject matter of any of Examples 116-118, and further specifies that modifying the function includes warping a frequency of the function proportionally to the scaling factor.

Example 120 includes the subject matter of any of Examples 116-119, and further includes providing the audio stream to a user device or an output audio device such as a loudspeaker or headphones.

Example 121 includes the subject matter of any of Examples 116-120, and further includes generating, based on the sensor data, a representation of the physical characteristic.

Example 122 includes the subject matter of any of Examples 116-121, and further includes selecting the model from a plurality of models based on the representation and a selection criterion.

Example 123 includes the subject matter of any of Examples 116-122, and further specifies that the representation is a 3D representation of the physical characteristic.

Example 124 includes the subject matter of any of Examples 116-123, and further specifies that the selection criterion is tailored to match a shape of the physical characteristic more than a size of the physical characteristic.

Example 125 includes the subject matter of any of Examples 116-124, and further specifies that selecting the model includes determining a volume of space between the representation of the physical characteristic and the plurality of models.

Example 126 includes the subject matter of any of Examples 116-125, and further specifies that the selection criterion includes selecting a model of the plurality of models having a smallest volume of space between the representation of the physical characteristic.

Example 127 includes the subject matter of any of Examples 116-126, and further specifies that the volume of space is determined using a plurality of optimization variables that include an origin, a rotation about the origin, and the scaling factor.

Example 128 includes the subject matter of any of Examples 116-127, and further specifies that selecting the model includes determining the scaling factor.

Example 129 includes the subject matter of any of Examples 116-128, and further specifies that the physical characteristic is a first physical characteristic, the model is a first model, the function is a first function, the audio response is a first audio response, and the modified function is a modified first function.

Example 130 includes the subject matter of any of Examples 116-129, and further specifies that the sensor data corresponds with a second physical characteristic of a user.

Example 131 includes the subject matter of any of Examples 116-130, and further includes scaling a second model to the second physical characteristic.

Example 132 includes the subject matter of any of Examples 116-131, and further includes modifying a second function, representing a second audio response, based on the scaled second model to produce a modified second function.

Example 133 includes the subject matter of any of Examples 116-132, and further includes combining the modified first function and the modified second function to form a combined function.

Example 134 includes the subject matter of any of Examples 116-133, and further specifies that generating the audio stream based on the modified function includes generating the audio stream based on the combined function.

Example 135 includes the subject matter of any of Examples 116-134, and further specifies that combining the modified first function and the modified second function to form the combined function includes determining a high-frequency component by applying a low-frequency filter to the modified first function.

Example 136 includes the subject matter of any of Examples 116-135, and further specifies that combining the modified first function and the modified second function to form the combined function includes determining a low-frequency component by applying a high-frequency filter to the modified second function.

Example 137 includes the subject matter of any of Examples 116-136, and further specifies that combining the modified first function and the modified second function to form the combined function includes combining the low-frequency component and the high-frequency component to form the combined function.

Example 138 includes the subject matter of any of Examples 116-137, and further specifies that the low-frequency filter includes an electronic filter that passes signals with a frequency lower than a cutoff threshold frequency and attenuates signals with frequencies higher than the cutoff threshold frequency.

Example 139 includes the subject matter of any of Examples 116-138, and further specifies that the high-frequency filter includes an electronic filter that passes signals with a frequency higher than a cutoff threshold frequency and attenuates signals with frequencies lower than the cutoff threshold frequency.

Example 149 includes the subject matter of any of Examples 116-139, and further specifies that the cutoff threshold frequency is set to about 3 kilohertz.

Example 141 includes the subject matter of any of Examples 116-140, and further specifies that the physical characteristic of the user is related to a head of the user or at least one pinna of the user.

Example 142 includes the subject matter of any of Examples 116-141, and further specifies that the sensor data is produced by an imaging device coupled to a mobile device.

Example 143 includes the subject matter of any of Examples 116-142, and further specifies that the sensor data are images captured by the imaging device while the user moves the mobile device around the head or the at least one pinna of the user based on a prompt provided via a display associated with the mobile device.

Example 144 includes the subject matter of any of Examples 116-143, and further specifies that the model is a head-and-torso model.

Example 145 includes the subject matter of any of Examples 116-144, and further specifies that the function is a head related transfer function associated with the model.

Example 146 includes the subject matter of any of Examples 116-145, and further specifies that the modified function is a head related transfer function personalized for the user.

Example 147 includes the subject matter of any of Examples 116-146, and further specifies that the sensor data includes environment data corresponding to an environment around the user.

Example 148 includes the subject matter of any of Examples 116-147, and further includes modifying the function based on the environment data.

Example 149 includes a computer-readable medium storing instructions that when executed by an electronic processor cause the electronic processor to perform the method as described in any of Examples 116-148.

What is claimed is:

1. A method comprising:
receiving sensor data corresponding with a physical characteristic of a user;
scaling a model to the physical characteristic;
modifying a function, representing an audio response, based on the scaled model to produce a modified function; and
generating an audio stream based on the modified function.

2. The method of claim 1, wherein scaling the model to the physical characteristic includes determining a scaling factor by scaling the model to match the physical characteristic.

3. The method of claim 2, wherein modifying the function includes modifying the function based on the scaling factor.

4. The method of claim 3, wherein modifying the function includes warping a frequency of the function proportionally to the scaling factor.

5. The method of claim 1, further comprising:
providing the audio stream to a user device.

6. The method of claim 1, further comprising:
generating, based on the sensor data, a representation of the physical characteristic; and
selecting the model from a plurality of models based on the representation and a selection criterion.

7. The method of claim 6, wherein the representation is a three-dimensional representation of the physical characteristic.

8. The method of claim 6, wherein the selection criterion is tailored to match a shape of the physical characteristic more than a size of the physical characteristic.

9. The method of claim 6, wherein selecting the model includes determining a volume of space between the representation of the physical characteristic and the plurality of models.

10. The method of claim 9, wherein the selection criterion includes selecting a model of the plurality of models having a smallest volume of space between the representation of the physical characteristic.

11. The method of claim 9, wherein the volume of space is determined using a plurality of optimization variables that include an origin, a rotation about the origin, and a scaling factor.

12. The method of claim 11, wherein selecting the model includes determining the scaling factor.

13. The method of claim 1, wherein the physical characteristic is a first physical characteristic, the model is a first model, the function is a first function, the audio response is a first audio response, and the modified function is a modified first function, and wherein the sensor data corresponds with a second physical characteristic of a user, the method further comprising:
scaling a second model to the second physical characteristic;
modifying a second function, representing a second audio response, based on the scaled second model to produce a modified second function;
combining the modified first function and the modified second function to form a combined function,
wherein generating the audio stream based on the modified function includes generating the audio stream based on the combined function.

14. The method of claim 13, wherein combining the modified first function and the modified second function to form the combined function includes:
determining a high-frequency component by applying a low-frequency filter to the modified first function;
determining a low-frequency component by applying a high-frequency filter to the modified second function; and
combining the low-frequency component and the high-frequency component to form the combined function.

15. The method of claim 14, wherein the low-frequency filter includes an electronic filter that passes signals with a frequency lower than a cutoff threshold frequency and attenuates signals with frequencies higher than the cutoff threshold frequency, and
wherein the high-frequency filter includes an electronic filter that passes signals with a frequency higher than a cutoff threshold frequency and attenuates signals with frequencies lower than the cutoff threshold frequency.

16. The method of claim 15, wherein the cutoff threshold frequency is set to about 3 kilohertz.

17. The method of claim 15, wherein the physical characteristic of the user is related to a head of the user or at least one pinna of the user.

18. The method of claim 17, wherein the sensor data is produced by an imaging device coupled to a mobile device, and wherein the sensor data are images captured by the imaging device while the user moves the mobile device around the head or the at least one pinna of the user based on a prompt provided via a display associated with the mobile device.

19. The method of claim 15, wherein the model is a head-and-torso model, and wherein the function is a head related transfer function associated with the model.

20. The method of claim 15, wherein the modified function is a head related transfer function personalized for the user.

21. A system comprising:
a computing device including an imaging sensor, and
an electronic processor coupled to the computing device and configured to:
receive, from the imaging sensor, sensor data corresponding with a physical characteristic of a user;
scale a model to the physical characteristic;
modify a function, representing an audio response, based on the scaled model to produce a modified function; and
provide an audio stream based on the modified function.

22. The system of claim 21, wherein the model is scaled to the physical characteristic by determining a scaling factor by scaling the model to match the physical characteristic.

23. The system of claim 22, wherein the function is modified based on the scaling factor.

24. The system of claim 23, wherein the function is modified by warping a frequency of the function proportionally to the scaling factor.

25. A method comprising:
modifying a function representing an audio response using on a model scaled to a physical characteristic of a user based on sensor data corresponding with the physical characteristic; and
generating an audio stream based on the modified function.

26. The method of claim 25, wherein the sensor data includes environment data corresponding to an environment around the user, the method further comprising modifying the function based on the environment data.

27. The method of claim 25, further comprising:
generating, based on the sensor data, a representation of the physical characteristic; and
selecting the model from a plurality of models based on the representation and a selection criterion.

28. The method of claim 25, wherein the physical characteristic is a first physical characteristic, the model is a first model, the function is a first function, the audio response is a first audio response, and the modified function is a modified first function, and wherein the sensor data corresponds with a second physical characteristic of a user, the method further comprising:
scaling a second model to the second physical characteristic;
modifying a second function, representing a second audio response, based on the scaled second model to produce a modified second function;
combining the modified first function and the modified second function to form a combined function,
wherein generating the audio stream based on the modified function includes generating the audio stream based on the combined function.

29. The method of claim 28, wherein combining the modified first function and the modified second function to form the combined function includes:
determining a high-frequency component by applying a low-frequency filter to the modified first function;
determining a low-frequency component by applying a high-frequency filter to the modified second function; and
combining the low-frequency component and the high-frequency component to form the combined function.

30. The method of claim 29, wherein the low-frequency filter includes an electronic filter that passes signals with a frequency lower than a cutoff threshold frequency and attenuates signals with frequencies higher than the cutoff threshold frequency, and
wherein the high-frequency filter includes an electronic filter that passes signals with a frequency higher than a cutoff threshold frequency and attenuates signals with frequencies lower than the cutoff threshold frequency.
